(19) United States
(12) Patent Application Publication
(10) Pub. No.: US 2009/0203834 A1
(43) Pub. Date: Aug. 13, 2009

(54) INK RECEIVING PARTICLES, RECORDING DEVICE, MATERIAL FOR RECORDING AND INK RECEIVING PARTICLE STORAGE CARTRIDGE

(75) Inventors: Eisuke Hiraoka, Kanagawa (JP); Takeshi Mikami, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/235,693

(22) Filed: Sep. 23, 2008

(30) Foreign Application Priority Data
Feb. 13, 2008 (JP) 2008-031666

(51) Int. Cl. C08L 33/10; C08F 20/06; G01D 11/00; B41J 2/175

(52) U.S. Cl. 524/560; 526/317.1; 347/100; 347/85

(57) ABSTRACT

Ink receiving particles for receiving an ink include hydrophilic particles that include a hydrophilic resin, in which the neutralization degree of the hydrophilic resin at a surface layer portion of the hydrophilic particles is higher than the neutralization degree of the hydrophilic resin at a central portion of the hydrophilic particles.

### CROSS-REFERENCE TO RELATED APPLICATIONS

This application is based on and claims priority under 35 USC 119 from Japanese Patent Application No. 2008-031666, filed Feb. 13, 2008.

### BACKGROUND

(i) Technical Field

The present invention relates to ink receiving particles. The invention also relates to a recording device, material for recording, and ink receiving particle storage cartridge using the ink receiving particles.

(ii) Related Art

The ink jet recording method is known as one method of recording images and data using ink. The mechanism of the ink jet recording method is such that the ink in the form of a liquid or a melted solid is ejected from a nozzle, slit, porous film or the like onto paper, cloth, film or the like to record. As a method of ejecting ink, various methods have been proposed such as a charge control method in which ink is ejected by electrostatic attraction force; a pressure pulse method in which ink is ejected by oscillation pressure of piezo elements; and a thermal ink jet method in which ink is ejected by pressure generated by forming and growing of air bubbles under high temperature. Images or data of extremely high definition can be recorded by these methods.

Among the recording methods using ink, including these ink jet recording methods, a method has been proposed in which an image is first recorded on an intermediate member, and the image is then transferred onto a recording medium, in order to record an image with high image quality on various types of recording media such as permeable media and impermeable media.

### SUMMARY

According to an aspect of the invention, ink receiving particles for receiving ink are provided which include hydrophilic particles that include a hydrophilic resin, in which the neutralization degree of the hydrophilic resin at a surface layer portion of the hydrophilic particles is higher than the neutralization degree of the hydrophilic resin at a central portion of the hydrophilic particles.

### BRIEF DESCRIPTION OF THE DRAWINGS

Exemplary embodiments of the present invention will be described in detail based on the following figures, wherein:

FIG. 1 is a schematic diagram that illustrates one example of ink receiving particles according to an exemplary embodiment;

FIG. 2 is a schematic diagram that illustrates another example of ink receiving particles according to an exemplary embodiment;

FIG. 3 illustrates a perspective view of an ink receiving particle storage cartridge according to an exemplary embodiment;

FIG. 4 illustrates a sectional view taken along line A-A in FIG. 3;

FIG. 5 is a configurational drawing that illustrates a recording device according to an exemplary embodiment;

FIG. 6 is a configurational drawing that illustrates main components of a recording device according to an exemplary embodiment;

FIGS. 7A and 7B are configurational drawings that illustrate ink receiving particle layers according to an exemplary embodiment;

FIG. 8 is a configurational drawing that illustrates a recording device according to another exemplary embodiment;

FIG. 9 is a configurational drawing that illustrates the main components of a recording device according to another exemplary embodiment; and

FIGS. 10A, 10B, and 10C schematically illustrate a process of image formation in a recording device according to another exemplary embodiment.

### DETAILED DESCRIPTION OF THE INVENTION

Next, an exemplary embodiment of the present invention will be described in detail.

### (Ink Receiving Particles)

Ink receiving particles of the exemplary embodiment receive an ink component when ink contact with the particles. Here, “ink receiving” indicates the retention of at least a part of the ink component (at least a liquid component).

Ink receiving particles in an exemplary embodiment of the invention include hydrophilic particles including a hydrophilic resin in which the neutralization degree of the hydrophilic resin at a surface layer portion of the hydrophilic particles is higher than the neutralization degree of the hydrophilic resin at a central portion of the hydrophilic particles.

In the ink receiving particles according to the present exemplary embodiment, a liquid absorbing property of the surface layer portion of the hydrophilic particles can be improved by making the neutralization degree of the hydrophilic resin at the surface layer portion of the hydrophilic particles, which portion exerts most of the liquid absorbing property for the liquid component of the ink, higher than the neutralization degree of the hydrophilic resin at the central portion of the hydrophilic particles. Further, image deterioration caused by moisture in the air after image fixing can be significantly reduced by making the neutralization degree of the hydrophilic resin at the central portion of the hydrophilic particles lower than the neutralization degree of the hydrophilic resin at the surface layer portion of the hydrophilic particles.

In the ink receiving particles according to the present exemplary embodiment, the hydrophilic particles are configured so that the neutralization degree of the hydrophilic resin contained in the particles differs between the surface layer portion and the central portion. Specifically, for example, the hydrophilic resin is synthesized with monomers which contain a polar monomer having a polar group, and the difference in the neutralization degree of the hydrophilic resin is caused by the difference in an amount of the polar group having a salt structure. In other words, in the present exemplary embodiment of the invention, the amount of the polar group having a salt structure is high in the surface layer portion. Further, in the present exemplary embodiment, the hydrophilic resin of the surface portion and the hydrophilic resin of the central portion may be different from each other.

Here, in order to obtain hydrophilic particles with this kind of configuration, the particles can be obtained, for example, by implementing a neutralization (salification) treatment (specifically, an alkali treatment, for example) after at least graining the hydrophilic resin into particles (for example, emulsification treatment of the hydrophilic resin). Because implementation of the neutralization treatment after the graining results in implementation of the neutralization (salification) treatment only at the surface layer portion of the particles, hydrophilic particles as configured above can be obtained. Additionally, the depth of the surface portion whose neutralization degree is enhanced by neutralization treatment may be adjusted by the treatment amount, time or the like of the neutralization treatment.

The hydrophilic particles have, as described above, a configuration in which the neutralization degree of the hydrophilic resin at their surface layer portion is higher than the neutralization degree of the hydrophilic resin at the central portion. Specifically, for example, they are configured such that the neutralization degree gradually decreases from the surface layer portion toward the central portion. Therefore, for example, the neutralization degree of the hydrophilic resin contained in the hydrophilic particles is preferably such that the neutralization degree of the hydrophilic resin at the surface layer portion at a depth from the surface of at least from 5% to 70% (preferably from 10% to 50%) with respect to the particle radius of the hydrophilic particles is higher than the neutralization degree of the hydrophilic resin at the central portion of the hydrophilic particles.

Here, in the hydrophilic particles, it is preferable for the neutralization degree of the hydrophilic resin in the surface layer portion to be from 0.1 or about 0.1 to 1 or about 1, more preferably to be from 0.2 or about 0.2 to 0.9 or about 0.9, and still more preferably to be from 0.3 or about 0.3 to 0.8 or about 0.8. On the other hand, it is preferable for the neutralization degree of the hydrophilic resin in the central portion to be from 0 or about 0 to 0.6 or about 0.6, more preferably to be from 0 or about 0 to 0.5 or about 0.5, and still more preferably to be from 0 or about 0 to 0.4 or about 0.4.

The method for measuring the neutralization degree is as follows. The neutralization degree of the hydrophilic particles is calculated by measuring (A) the amount of (COOH) left on the surface of the material by neutralization titration using KOH, subsequently measuring (B) the amount of (COO⁻) present on the surface of the material after neutralization by titration using HCl. The amount of salt structure present on the surface is (B)−(A), and the neutralization degree is calculated by using the equation “neutralization degree=[(B)−(A)]/(B)”.

Specifically, utilizing the properties of high hydrophilicity of the hydrophilic resin in the surface layer portion of the hydrophilic particles owing to the high neutralization degree, and low hydrophilicity (high hydrophobicity) of the hydrophilic resin in the central portion owing to the low neutralization degree, the surface layer portion and the central portion are separated.

As a preliminary preparation, the average spherical equivalent diameter of the hydrophilic particles is measured in advance by a laser diffraction particle size distribution analyzer (manufactured by HORIBA, LTD., LA-700). Further, five kinds of water/IPA mixed solution are prepared as follows: water/IPA=100/0 (weight ratio) (first solution), water/IPA=75/25 (second solution), water/IPA=50/50 (third solution), water/IPA=25/75 (fourth solution), and water/IPA=0/100 (fifth solution).

The hydrophilic particles are added to the first solution, then stirred and dispersed, and the average spherical equivalent diameter of the particles in the solution is measured in the same way. Subsequently, the hydrophilic particles are added to the second solution and the same treatment and measurement performed and, further, the same treatments and measurements are performed with the hydrophilic particles in the third and the fourth solutions.

Here, when the average particle diameter has changed (average particle diameter has decreased), this shows that the high neutralization degree portion at the surface layer portion has dissolved in the solution and the low neutralization degree portion inside the particles remains as particles without dissolving, showing that the high neutralization degree portion at the surface layer portion and the low neutralization degree portion in the central portion have been successfully separated.

Regarding the solution in which the particle diameter has decreased, a liquid component and a solid component are separated by a centrifugal separation treatment and, further, by a cleaning treatment using an IPA aqueous solution of the same concentration.

Next, the solid component is added to a solution having a higher IPA concentration than the above-described solution, and the solid component is further dissolved by stirring.

Such operations are carried out using the five kinds of water/IPA mixed solution described above, and when the average particle diameter first becomes equal to or less than 30% of the original average particle diameter in the treatment in one solution, the entire liquid component obtained before the treatment in the solution is designated “liquid a”, the liquid component obtained only when the average particle diameter first becomes equal to or less than 30% of the original average particle diameter is designated “liquid b”, and the entire liquid component obtained thereafter is designated “liquid c”, and these liquids are collected.

An example is explained when the operations described above are carried out using five kinds of water/IPA mixed solution. When the average particle diameter becomes, for example, 29% of the original average particle diameter during dissolving the hydrophilic particles into the third water/IPA mixed solution (water/IPA=50/50), “liquid b” is the liquid component obtained by the third solution (water/IPA=50/50). The liquid component obtained by the first solution (water/IPA=100/0) and the liquid component obtained by the second solution (water/IPA=75/25) are collected as “liquid a”, and the liquid component obtained by the fourth solution (water/IPA=25/75) and the liquid component obtained by the fifth solution (water/IPA=0/100) are collected as “liquid c”.

Then, the following operations are performed with respect to the respective liquid components “liquid a” and “liquid c”.

The consumption of KOH is measured in accordance with JIS K2501 acid value potentiometry (a potentiometer and a pH meter are used in the measurement), the disclosure of JIS K2501 is incorporated by reference herein, and (A) the amount (mol quantity) of (COOH) is calculated. Subsequently an HCl aqueous solution is used as a titration solution, the consumption of HCl is measured in accordance with JIS K2501 acid value potentiometry (a potentiometer and a pH meter are used in measurement), and (B) the amount (mol quantity) of (COO⁻) is calculated. The neutralization degree is calculated by using the equation “neutralization degree=[(B)−(A)]/(B)”.

The neutralization degree of the surface layer of the hydrophilic particles is calculated from the result obtained using “liquid a”, and the neutralization degree of the in the central portion of the hydrophilic particles is calculated from the result obtained using “liquid c”, respectively in accordance with the aforementioned equation.

Next, the particle configuration of the ink receiving particles according to the present embodiment will be described.

The ink receiving particles according to the present embodiment may be composed of single particles of hydrophilic particles (also referred to as “primary particles” in the following) including the above-described hydrophilic resin, and may be composite particles formed by aggregating at least hydrophilic particles. The single hydrophilic particle or the composite particle made by aggregating at least hydrophilic particles may be referred to as a “host particle”.

Additionally, when the host particle consists of a primary particle, the host particle may be obtained by further particulating at least the hydrophilic resin (for example, emulsifying the hydrophilic resin), then performing neutralization (salification) treatment (specifically, for example, alkali treatment) to obtain an emulsified liquid (emulsion liquid), and then performing, for example, drying treatment such as freeze drying. Further, when the host particles consist of composite particles, the host particles may be obtained by particulating at least the hydrophilic resin (for example, emulsifying the hydrophilic resin), then performing neutralization (salification) treatment (specifically, for example, alkali treatment) to obtain an emulsified liquid (emulsion liquid), and then performing, for example, drying and granulation (composition) treatment such as spray drying. Further, when the composite particles are composed by composition of hydrophilic particles with other particles (inorganic particles, hydrophobic particles, wax particles or the like), they may be obtained, for example, by mixing the other particles into the emulsified liquid (emulsion liquid), and then performing the drying and granulation (complexion) treatment.

Here, in the case of a configuration whereby the ink receiving particles consist of single particles of hydrophilic particles, when ink receiving particles receive ink, ink is attached to ink receiving particles whereupon at least a liquid component of the ink is absorbed by the hydrophilic particles.

Thus, the ink receiving particles receive the ink. Then, recording is performed by transferring the ink receiving particles that have received the ink to a recording medium.

Further, in the case of a configuration whereby the ink receiving particles consist of composite particles in which at least hydrophilic particles are aggregated, when the ink receiving particles receive ink, ink is first attached to the ink receiving particles and then at least a liquid component of ink is trapped by a void (a void between particles is also referred to as a “trap structure” in the following) between the particles (at least hydrophilic particles) constituting the composite particles. At this time, a recording material among the ink components is attached to an ink receiving particle surface or trapped by the trap structure. Then, the ink present in the voids is absorbed by the particles. Thus, the ink receiving particles receive the ink. Then, recording is performed by transferring the ink receiving particles that have received the ink to a recording medium.

The trapping of the ink component (liquid component; recording material) by this trap structure is a physical and/or chemical trap by a void between particles (a physical particle wall structure).

By employing a configuration using composite particles in which at least hydrophilic particles are aggregated, the ink liquid component is absorbed and retained by the hydrophilic particles as well as being trapped by voids (a physical particle wall structure) between particles constituting the composite particles.

After transferring the ink receiving particles, a component of the hydrophilic particles of the ink receiving particles functions also as a binder resin or a coating resin of a recording material contained in the ink. In particular, a transparent resin may be applied as the component of the hydrophilic particles of the ink receiving particles.

The addition of a large amount of resin to an ink is necessary for improving the fixity (abrasion resistance) of an ink (for example, a pigment ink) using, for example, an insoluble component or dispersed particulate matter such as a pigment as a recording material; however, the addition of a large amount of a polymer to ink (including the treatment solution) reduces reliability with respect to nozzle clogging or the like of an ink ejecting portion. In contrast, in the exemplary embodiments of the present invention, a resin component of the ink receiving particles can also function as the resin.

Here, “the void between the particles constituting the composite particles”, namely, “the trap structure”, is a physical particle wall structure capable of trapping at least liquid. The size of the void may be in the range of from 0.1 μm to 5 μm, and preferably from 0.3 μm to 1 μm, at the largest opening diameter. In particular, the size of the void is preferably a size capable of trapping a recording material, for example, a pigment having a volume-average particle diameter of 100 nm. A micropore having a maximum opening diameter of less than 50 nm may be present. Voids or capillary tubes may communicate each other inside the particles.

The void size is determined as follows. A scanning electron microscope (SEM) image of the particle surface is read by an image analyzer, voids are detected by binary coding processing, and the size and distribution of the voids are analyzed and thus determined.

It is preferable that the trap structure traps not only the liquid component from the ink components but also the recording material. When the recording material, particularly a pigment, is trapped in the trap structure together with the ink liquid component, the recording material is retained and fixed within the ink receiving particles without being unevenly distributed. The ink liquid component may be ink solvents or dispersion media (vehicle liquids).

The particle configuration of the ink receiving particles according to the present embodiment is described in further detail below. The ink receiving particles according to the present embodiment, as described above, may have a configuration such that the host particles consist of single particles of hydrophilic particles, or a configuration such that the host particles consist of composite particle in which at least hydrophilic particles have been aggregated.

Further, components other than the resin (for example, inorganic material, hydrophobic resin, releasing agent (wax) and on the like) may be included in the hydrophilic particles. Further, examples of particles constituting the composite particles other than the liquid absorbing particles include inorganic particles, hydrophobic particles, releasing agent particles (wax particles) and the like.

Further, inorganic particles may be attached to the host particles at the surface of the hydrophilic particles or the composite particles.

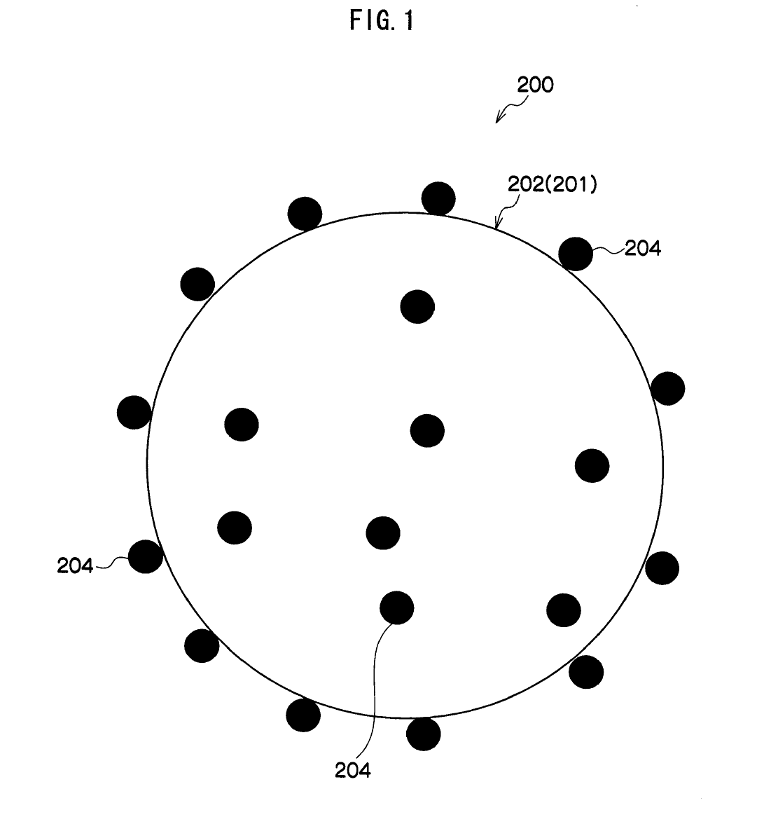

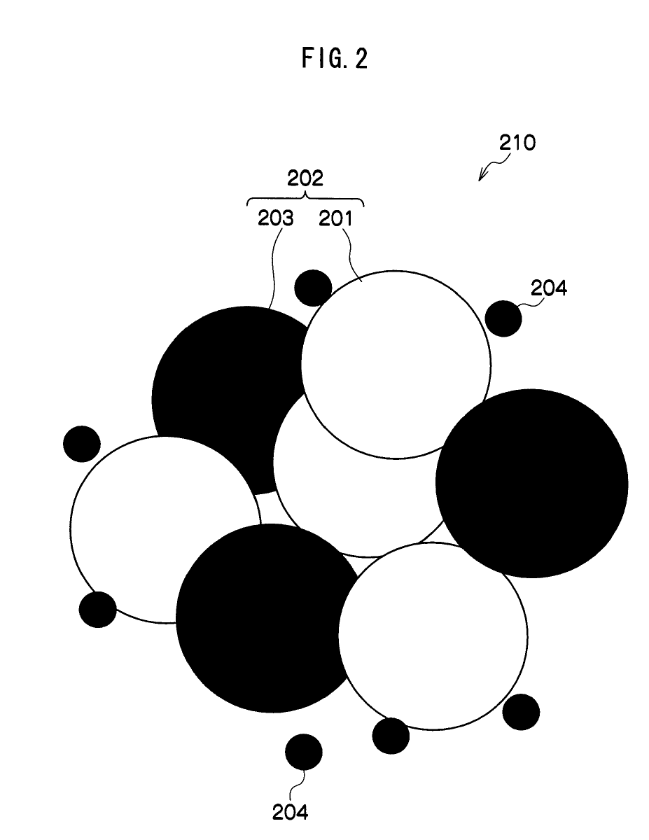

Example of a specific configuration of the ink receiving particles according to the present embodiment include a configuration in which ink receiving particles 200 have host particles 202 composed of single particles of hydrophilic particles 201, and inorganic particles 204 attached to the surface of the host particles 202 (hydrophilic particles 201), as shown in FIG. 1. Another example is a configuration in which ink receiving particles 210 have host particles 202 formed of composite particles composed of hydrophilic particles 201 and other particles 203 (such as inorganic particles, hydrophobic particles configured to include a hydrophobic resin, and wax particles), and inorganic particles 204 attached to the surface of the host particles 202 (the composite particles), as shown in FIG. 2. The composite particles have a void structure formed by voids between respective particles. Moreover, these configurations are single examples, and the present invention is not limited thereto and, for example, in another configuration, the inorganic particles 204 may not be adhered (external addition) or, alternatively, the composite particles may be composed only of the hydrophilic particles 201.

The average spherical equivalent diameter of the ink receiving particles as a whole may be in the range of 0.5 to 50 μm (preferably 1 μm to 30 μm, more preferably 3 μm to 20 μm, and still more preferably 5 μm to 10 μm).

The average spherical equivalent diameter is determined as follows. The optimum method depends on particle size; however, for example, a method in which the particle diameter is determined by applying the principle of light scattering to a dispersion of the particles in a liquid, or a method in which the particle size is determined by image processing of a projected image of the particles, or other methods may be utilized. Examples of methods generally used include a Microtrack UPA method or a Coulter counter method.

When the host particles are composite particles, the weight ratio between the hydrophilic particles and other particles (hydrophilic particles: other particles) is, for example, in a range of 5:1 to 1:10 when the other particles are inorganic particles.

With regard to the particle diameter of host particles, the average spherical equivalent diameter may be from 0.1 to 50 μm, preferably from 0.5 to 25 μm and more preferably from 1 to 10 μm. When the average spherical equivalent diameter is in this range, high image quality can be achieved. That is, when the average spherical equivalent diameter is large, a step difference occurs in the height direction between a portion where particles are present and a portion where particles are not present on the image, and thus the smoothness of the image may be degraded. On the other hand, when the average spherical equivalent diameter is small, powder becomes more difficult to handle, and it tends to become difficult to supply powder to a given position on a transfer member. As a result, a portion at which hydrophilic particles are not present occurs on the image, and it may become difficult to achieve high speed recording and high image quality. When the ink receiving particles consist of primary particles, it is preferable to apply the above range of average spherical equivalent diameter.

When the host particles consist of composite particles, the BET specific surface area thereof (N₂) is, for example, in a range of from 1 to 750 m²/g.

When the host particles consist of the composite particles, the composite particles are obtained by, for example, granulating the particles in a semi-coalesced state. A semi-coalesced state signifies a state in which the particle shape remains to some degree and voids are retained between the particles. With regard to the composite particles, when an ink liquid component is trapped by the trap structure, at least a part of the particles may be dissociated, that is, the composite particles may be dismantled and particles composing these composite particles may be disjoined.

Additionally, regarding the particle diameter of the hydrophilic particles, when the primary particles are used as the host particles, the average spherical equivalent diameter is, for example, within the range of from 0.1 μm to 50 μm, preferably from 0.5 μm to 25 μm, and more preferably from 1 μm to 10 μm. Further, when the hydrophilic particles are used in the composite particles, regarding the particle diameter of the hydrophilic particles, the average spherical equivalent diameter is, for example, within the range of from 10 nm to 30 μm, preferably from 50 nm to 1 μm, and more preferably from 50 nm to 700 nm.

Further, the ratio of the hydrophilic particles with respect to the ink receiving particles as a whole is, for example, not less than 75% by weight, preferably not less than 85% by weight, and more preferably within the range of from 90% by weight to 99% by weight.

Respective materials are explained below in further detail. First, the hydrophilic resin will be described. The hydrophilic resin preferably has a polar group and is a resin in which the ratio of the polar monomer with respect to the entire monomer components is from 10% by mol to 100% by mol.

In the hydrophilic resin, a polar monomer having a polar group that does not have a salt structure may be used, or a monomer in which at least one part of the polar group has a salt structure may be used. After particulating the hydrophilic resin, the neutralization degree in the surface layer portion of the particle is increased by performing a neutralization treatment; that is, the ratio of the salt structure in the polar group is increased.

Examples of the salt structures of the polar group include a salt structure of an alkali metal, a salt structure of a polyvalent metal, and a salt structure of an organic amine. In other words, the neutralization treatment may be performed using these respective materials.

Examples of the alkali metal for addition of the salt structure of an alkali metal include alkali metals such as lithium chloride, sodium chloride, potassium chloride, sodium bromide, potassium bromide, sodium iodide, potassium iodide, sodium sulfate, potassium nitrate, sodium acetate, potassium oxalate, sodium citrate, potassium benzoate or the like, and salts thereof.

Examples of the polyvalent metal for addition of the salt structure of a polyvalent metal include polyvalent metals such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, benzoic acid calcium, calcium acetate, salicylic acid calcium, tartaric acid calcium, calcium lactate, fumaric acid calcium, citric acid calcium, copper chloride, copper bromide, copper sulfate, copper nitrate, copper acetate, iron chloride, iron bromide, iron iodide, iron sulfate, iron nitrate, iron oxalate, lactic acid iron, fumaric acid iron, citric acid iron, magnesium chloride, magnesium bromide, magnesium iodide, magnesium sulfate, magnesium nitrate, magnesium acetate, magnesium lactate, manganese chloride, manganese sulfate, manganese nitrate, dihydrogenphosphate manganese, manganese acetate, salicylic acid manganese, benzoic acid manganese, manganese lactate, nickel chloride, nickel bromide, nickel sulfate, nickel nitrate, nickel acetate, sulfuric acid tin, titanium chloride, zinc chloride, zinc bromide, zinc sulfate, zinc nitrate, zinc thiocyanate, zinc acetate or the like, and salts thereof.

Examples of the organic amine for addition of the salt structure of an organic amine include, as the organic amine, a primary amine, secondary amine, tertiary amine or salts thereof, and quaternary ammonium salt.

Specific examples thereof include alkylamine, alkyl ammonium, alkanol amine, alkanol ammonium, arylamine, pyridium, imidazolium, polyamine and derivatives or salts thereof.

Further examples of the organic amine include amylamine, butyl amine, propanol amine, propyl amine, ethanol amine, ethyl ethanol amine, 2-ethyl hexyl amine, ethyl methyl amine, ethyl benzyl amine, ethylene diamine, octyl amine, oleyl amine, cyclooctyl amine, cyclobutyl amine, cyclopropyl amine, cyclohexyl amine, diisopropanol amine, diethanol amine, diethyl amine, di(2-ethylhexyl amine), diethylene triamine, diphenyl amine, dibutyl amine, dipropyl amine, dihexyl amine, dipentyl amine, 3-(dimethyl amino)propyl amine, dimethyl ethyl amine, dimethyl ethylene diamine, dimethyl octyl amine, 1,3-dimethyl butyl amine, dimethyl-1,3-propane diamine, dimethyl hexyl amine, amino butanol, amino propanol, amino propane diol, N-acetyl amino ethanol, 2-(2-amino ethyl amino)-ethanol, 2-amino-2-ethyl-1,3-propane diol, 2-(2-amino ethoxy)ethanol, 2-(3,4-dimethoxy phenyl)ethyl amine, cetyl amine, triisopropanol amine, triisopentyl amine, triethanol amine, trioctyl amine, trityl amine, bis(2-aminoethyl) 1,3-propane diamine, bis(3-aminopropyl)ethylene diamine, bis(3-aminopropyl) 1,3-propane diamine, bis(3-amino propyl)methyl amine, bis(2-ethyl hexyl)amine, bis(trimethyl silyl)amine, butyl amine, butyl isopropyl amine, propane diamine, propyl diamine, hexyl amine, pentyl amine, 2-methyl-cyclohexyl amine, methyl-propyl amine, methyl benzyl amine, monoethanol amine, lauryl amine, nonyl amine, trimethyl amine, triethyl amine, dimethyl propyl amine, propylene diamine, hexamethylene diamine, tetraethylene pentamine, diethyl ethanol amine, tetramethyl ammonium chloride, tetraethyl ammonium bromide, dihydroxy ethyl stearyl amine, 2-heptadecenyl-hydroxyethyl imidazoline, lauryl dimethyl benzyl ammonium chloride, stearamid methylpyridium chloride, alkyltrimethylammonium chloride, distearyl dimethylammonium chloride, stearyl dimethylbenzyl ammonium chloride, stearyl trimethylammonium chloride, cetyltrimethylammonium chloride, cetylpyridinium chloride, benzalkonium chloride, benzethonium chloride, lauryl trimethylammonium chloride, and hydrochloric acid alkyl diamino ethyl glycin. Also, the examples include diallyl dimethyl ammonium chloride polymer, diallyl amine polymer, and monoallyl amine polymer.

Examples of the organic amine include long-chain alkylammonium salts, long-chain alkylpyridinium salts, pyridinium, alkylamine compounds, and alkanolamine. Specific examples include triethanolamine, triisopropanolamine, 2-amino-2-ethyl-1,3-propanediol, ethanolamine, propane diamine, propylamine, lauryl dimethylbenzyl ammonium chloride, stearamidemethylpyridium chloride, alkyltrimethylammonium chloride, distearyldimethylammonium chloride, stearyldimethylbenzylammonium chloride, stearyltrimethylammonium chloride, cetyltrimethylammonium chloride, cetylpyridinium chloride, benzalkonium chloride, benzethonium chloride and lauryltrimethylammonium chloride.

Further, the polar monomer containing the polar group is a monomer containing, for example, an ethylene oxide group, carboxylic acid, sulfonic acid, a substituted or unsubstituted amino group or a hydroxy group as the polar group. For example, when adding a positive charging property, it may be a monomer containing, for example, a (substituted) amino group or a (substituted) pyridyl group. When adding negative charge, it may be a monomer of an organic acid containing carboxylic acid, sulfonic acid or the like. Carboxylic acid is particularly advantageous in terms of storage stability because it tends not to dissociate due to humidity in the air but dissociates in ink (a slightly alkaline liquid) when it is not neutralized (when not having a salt structure). Further, carboxylic acid is advantageous in terms of fixing property because it cross-links (pseudo-cross-links) via ions in ink and the entire system (ink+ink receiving particles) is easily fixed.

The ratio of polar monomer is calculated in the following manner. The composition of an organic component is first specified from analysis procedures such as mass spectrometric analysis, nuclear magnetic resonance (NMR) and infrared absorption spectra (IR). Thereafter, the acid value and base value of the organic component are measured in conformance with JIS K0070 or JIS K2501, the disclosures of which are incorporated by reference herein. The ratio of the polar monomer can be calculated from the composition and acid value/base value of the organic component. The same applies to the following.

The hydrophilic resin can soften and contribute to fixability for the reason that an ink liquid component (such as water or aqueous solvent) absorbed therein functions as a plasticizer of the resin (polymer).

The hydrophilic resin is preferably a weak liquid absorbing resin. This weak liquid absorbing resin signifies a liquid absorbing resin capable of absorbing from several percent (approximately 5%) to several hundred percent (approximately 500%), and preferably from about 5% to 100%, with respect to resin weight when, for example, absorbing water as the liquid.

When the hydrophilic property of the hydrophilic resin (weak liquid absorbing resin) is less than 5%, the ink holding ability of the ink receiving particles degrades, and when it exceeds 500%, the moisture absorption of the ink receiving particles is activated, and there are cases when stability with respect to variation in ambient conditions decreases.

The hydrophilic resin can be composed of, for example, a homopolymer of a hydrophilic monomer or a copolymer composed of monomers of both a hydrophilic monomer and a hydrophobic monomer; however, the copolymer may be used to obtain a weak liquid absorbing resin. The hydrophilic resin may be composed not merely of a monomer but also a graft copolymer or a block copolymer in which a starting unit such as a polymer/oligomer structure is copolymerized with another unit.

Examples of the hydrophilic monomer include a monomer containing —OH, an -EO unit (ethylene oxide group), —COOM (where M is, for example, hydrogen, an alkali metal such as Na, Li and K, ammonia, or an organic amine), —SO₃M (where M is, for example, hydrogen, an alkali metal such as Na, Li and K, ammonia, or an organic amine), —NR₃ (where R is, for example, H, alkyl or phenyl), and —NR₄X (where R is, for example, H, alkyl or phenyl, and X is, for example, halogen, sulfate group, an acid anion such as carboxylic acid, or BF₄). Specific examples thereof include 2-hydroxyethyl methacrylate, 2-hydroxyethyl acrylate, acrylamide, acrylic acid, methacrylic acid, unsaturated carboxylic acid, crotonic acid and maleic acid. Examples of a hydrophilic unit or monomer include cellulose derivatives such as cellulose, ethyl cellulose and carboxymethyl cellulose, starch derivatives, monosaccharides/polysaccharides derivatives, polymerizable carboxylic acids and (partially) neutralized salts thereof such as vinyl sulfonic acid, styrenesulfonic acid, acrylic acid, methacrylic acid and maleic acid (anhydride), vinyl alcohols, derivatives and onium salts thereof such as vinylpyrrolidone, vinylpyridine, amino(meth)acrylate and dimethylamino(meth)acrylate, amides such as acrylamide and isopropylacrylamide, polyethylene oxide chain-containing vinyl compounds, hydroxyl group-containing vinyl compounds, and polyesters composed of multifunctional carboxylic acid and polyhydric alcohol, particularly, branched polyester containing tri- or higher functional acid such as trimellitic acid as a component and containing terminal carboxylic acid and hydroxyl group in large quantities, and polyester containing a polyethylene glycol structure.

The hydrophobic monomers are monomers having a hydrophobic group, and specific examples include olefin (ethylene, butadiene, or the like), styrene, α-methyl styrene, α-ethyl styrene, methyl methacrylate, ethyl methacrylate, butyl methacrylate, acrylonitrile, vinyl acetate, methyl acrylate, ethyl acrylate, butyl acrylate, lauryl methacrylate, and the like. Examples of a hydrophobic unit or monomer include styrene derivatives such as styrene, a-methyl styrene, vinyl toluene; polyolefines such as vinyl cyclohexane, vinyl naphthalene, vinyl naphthalene derivatives, alkyl acrylate, phenyl acrylate, alkyl methacrylate, phenyl methacrylate, cycloalkyl methacrylate, alkyl crotonate, dialkyl itaconate, dialkyl maleate, polyethylene, ethylene/vinyl acetate, polypropylene, or the like; and derivatives thereof.

Specific examples of the hydrophilic resin composed of a copolymer of a hydrophilic monomer and a hydrophobic monomer include olefin polymers (or modified versions, or versions into which a carboxylic acid unit is introduced by copolymerization, or the like) such as (meth)acrylate, styrene/(meth)acrylate/(anhydrous) maleic acid copolymer, ethylene/propylene, or the like, branched polyesters enhanced in acid value by trimellitic acid or the like, polyamides, and the like.

The hydrophilic resin may include a substituted or unsubstituted amino group, or a substituted or unsubstituted pyridine group. These groups exert a bactericidal effect and an interaction with a recording material (such as pigments and dyes) having anionic groups.

Here, in the hydrophilic resin, the molar ratio (hydrophilic monomer: hydrophobic monomer) between a hydrophilic unit (hydrophilic monomer) and a hydrophobic unit (hydrophobic monomer) is, for example, 5:95 to 70:30.

The hydrophilic resin may be ion cross-linked by ions supplied from ink. Specifically, units containing a carboxylic acid can be made present in the hydrophilic resin, such as a copolymer containing a carboxylic acid such as (meth)acrylic acid or maleic acid, or a (branched) polyester having a carboxylic acid. Ion cross-linking and an acid-base interaction or the like are caused between the carboxylic acid in the resin, and an alkali metal cation, alkaline earth metal cation, organic amine onium cation or the like supplied from liquid such as water-based ink.

The hydrophilic resin may have a straight-chain structure but preferably has a branch structure. The resin may be either not cross-linked or low cross-linked. Further, the resin may be a random copolymer or block copolymer with a straight-chain structure, but a polymer with a branch structure (including a random copolymer, block copolymer and graft copolymer with a branch structure) can be used. In the case, for example, of polyester synthesized by polycondensation, terminal groups can be increased with a branch structure. One general method for synthesizing this branch structure is to add a crosslinking agent such as divinylbenzene or di(meth)acrylates at the time of synthesis (for example, addition of less than 1%) and adding large quantities of an initiator together with the cross-linking agent.

In the hydrophilic resin, a charge control agent for electrophotographic toner may further be added to the resin, such as low-molecular quaternary ammonium salts, organic borates, or halogenated compounds of salicylic acid derivatives.

The hydrophilic resin is preferably an amorphous resin, and the glass transition temperature (Tg) thereof is, for example, from 40° C. to 90° C. The glass transition temperature (and melting point) is determined from the major maximum peak measured in accordance with ASTMD 3418-8. The major maximum peak can be measured by using a DSC-7 (manufactured by Perkin Elmer). In this apparatus, the temperature of the detection unit is corrected using the melting point of indium and zinc, and the calorimetric value is corrected using the fusion heat of indium. For the sample, an aluminum pan is used, and for the control, an empty pan is set. Measurement is conducted at a temperature elevation rate of 10° C./min.

The weight-average molecular weight of the hydrophilic resin is, for example, preferably from 5,000 or about 5,000 to 100,000 or about 100,000; more preferably from 7,500 or about 7,500 to 70,000 or about 70,000; still more preferably from 10,000 or about 10,000 to 50,000 or about 50,000. When the weight-average molecular weight is within this range, liquid absorption of the ink receiving particles is improved, and fixability is also improved.

The weight-average molecular weight is measured under the following conditions. For example, the GPC apparatus used is an HLC-8120GPC, SC-8020 (manufactured by TOSOH CORPORATION), two pieces of TSK gel, Super HM-H (manufactured by TOSOH CORPORATION, 6.0 mm ID×15 cm) are used as the column, and the eluent is THF (tetrahydrofuran). The experiment is carried out under the following experimental conditions: a sample concentration of 0.5%, flow rate of 0.6 ml/min, sample injection amount of 10 μl, measuring temperature of 40° C., and using an IR detector. A calibration curve is prepared from ten samples of polystyrene standard samples TSK standard manufactured by TOSOH CORPORATION: A-500, F-1, F-10, F-80, F-380, A-2500, F-4, F-40, F-128 and F-700.

The acid value of the hydrophilic resin is preferably from 50 mgKOH/g to 500 mgKOH/g, and more preferably from 100 mgKOH/g to 300 mgKOH/g as expressed by carboxylic acid groups (—COOH). The acid value as expressed by carboxylic acid groups (—COOH) can be measured as follows.

The acid value is measured using a neutralization titration method in accordance with JIS K 0070. That is, an appropriate amount of sample is prepared and, to this sample, 100 ml of solvent (diethyl ether/ethanol mixture) is added together with several droplets of indicator (phenolphthalein solution). The resulting mixture is shaken and mixed sufficiently in a water bath until the sample is dissolved. The solution is titrated with 0.1 mol/L of potassium hydroxide ethanol solution, and an end point is determined when a pale scarlet color of the indicator continues for 30 seconds. Acid value A is calculated by the following equation:

A=(B×f×5.611)/S,

when S (g) represents a sampling amount, B (ml) represents the amount of 0.1 mol/l potassium hydroxide ethanol solution used for the titration, and f represents a factor of 0.1 mol/l potassium hydroxide ethanol solution.

It is preferable that the hydrophilic resin explained above is used while controlling the ratio of polar monomer within the aforementioned range irrespective of the configuration of the resin. Further, although the ink receiving particles (hydrophilic particles) may contain, as a resin, a hydrophobic resin in addition to the hydrophilic resin, among the resin contained, the ratio of the hydrophilic resin with respect to the ink receiving particles as a whole is preferably from 80% to 100% by weight. When the ratio is within this range, both the hydrophilic property and water absorbing property of the ink receiving particles will increase.

Next, the inorganic particles used in the composite particles together with the hydrophilic particles, and the inorganic particles attached to the host particles are described. Both nonporous particles and porous particles can be used as the inorganic particles. Examples of the inorganic particles include colorless, light-colored or white particles (such as colloidal silica, alumina, calcium carbonate, zinc oxide, titanium oxide and tin oxide). Surface treatment (such as partial hydrophobizing treatment and specific functional group introduction treatment) may be performed for these inorganic particles. For example, in the case of silica, an alkyl group is introduced by treating the hydroxyl group of silica with a silylation agent such as trimethylchlorosilane or tert-butyldimethylchlorosilane. Dehydrochlorination is caused by the silylation agent and the reaction is promoted. Here, the addition of an amine can also change hydrochloric acid into hydrochloride to promote the reaction. The control can be performed by controlling the treatment amount and treatment conditions of silane coupling agents having an alkyl group or phenyl group as a hydrophobic group, and of coupling agents of titanate, zirconate or the like. Surface treatment with fatty alcohols, higher fatty acids and derivatives thereof can also be performed. Surface treatment can also be performed with coupling agents having a cationic functional group such as silane coupling agents having (substituted) an amino group or quaternary ammonium salt structure, coupling agents having a fluorine functional group such as fluorosilane, and coupling agents having an anionic functional group such as carboxylic acid. These inorganic particles may be contained inside the hydrophilic particles; that is, internally added.

The particle diameter of the inorganic particles used in the composite particles is, for example, 10 nm to 30 μm, preferably 50 nm to 10 μm and more preferably 0.1 μm to 5 μm in average spherical equivalent diameter. Further, the particle diameter of the inorganic particles attached to the host particles is, for example, 10 nm to 1 μm, preferably 10 nm to 0.1 μm and more preferably 10 nm to 0.05 μm in average spherical equivalent diameter.

Other constituent materials shall be explained below.

The ink receiving particles may include a hydrophobic resin. The hydrophobic resin may be included in the hydrophilic particles together with the hydrophilic resin. Hydrophobic particles containing hydrophobic resin may be included in the composite particles together with the hydrophilic particles. Additionally, the hydrophobic resin preferably has a polar group and is preferably a resin in which the ratio of the polar monomer with respect to the entire monomer components is from 0% by mol to 10% by mol.

A releasing agent (wax) may be included in the ink receiving particles. The releasing agent may be included in the hydrophilic particles together with the hydrophilic resin. Releasing agent particles (wax particles) may be included in the composite particles together with the hydrophilic particles.

Examples of the releasing agent include low molecular polyolefins such as polyethylene, polypropylene and polybutene; silicones having a softening point caused by heating; fatty acid amides such as oleic amide, erucic amide, ricinoleic amide and stearic amide; vegetable waxes such as carnauba wax, rice wax, candelilla wax, Japan wax and jojoba oil; animal waxes such as beeswax; mineral or petroleum waxes such as montan wax, ozokerite, ceresin, paraffin wax, microcrystalline wax and Fischer-Tropsch wax; and modifications thereof. Among these, use of crystalline compounds is preferred.

The ink receiving particles according to the present embodiment as described above may be used singly or in combination with a carrier. For example, a carrier used for a developing agent for toner for electrophotography may be used as the carrier.

(Material for Recording)

A material for recording of the present embodiment includes ink containing at least a recording material, and the above-mentioned ink receiving particles according to the present embodiment. The material for recording can perform recording due to the ink receiving particles receiving ink and thereafter being transferred to the recording medium.

Hereinafter, details of the ink used in the above exemplary embodiment will be described. In the embodiment, a water-based ink is used. The water-based ink (hereinafter, simply referred to as an ink) may contain an ink solvent (for example, water or a water soluble organic solvent), in addition to a recording material. As required, other additives may be also contained in the ink.

Details of the recording material will now be explained. A colorant may be used as the recording material, which may be either a dye or a pigment, but is preferably a pigment. Either an organic pigment or an inorganic pigment can be used as the pigment. Examples of the black pigments include carbon black pigments such as furnace black, lamp black, acetylene black, and channel black. In addition to black and three primary colors of cyan, magenta and yellow, other pigments of specific colors such as red, green blue, brown or white, metal glossy pigments of gold, silver or the like, body pigments of colorless or pale color, plastic pigments, or the like. A pigment newly synthesized for the invention may also be used.

Further, particles composed of a core of silica, alumina, polymer bead or the like on which a dye or a pigment is fixed, an insoluble lake compound of a dye, a colored emulsion, a colored latex or the like can also be used as a pigment.

Specific examples of the black pigments used in the present invention include RAVEN 7000, RAVEN 5750, RAVEN 5250, RAVEN 5000 ULTRA II, RAVEN 3500, RAVEN 2000, RAVEN 1500, RAVEN 1250, RAVEN 1200, RAVEN 1190 ULTRA II, RAVEN 1170, RAVEN 1255, RAVEN 1080 and RAVEN 1060 (manufactured by Columbian Carbon Company); REGAL 400R, REGAL 330R, REGAL 660R, MOGUL L, Black Pearls L, MONARCH 700, MONARCH 800, MONARCH 880, MONARCH 900, MONARCH 1000, MONARCH 1100, MONARCH 1300 and MONARCH 1400 (manufactured by Cabot Corporation); Color Black FW1, Color Black FW2, Color Black FW2V, Color Black 18, Color Black FW200, Color Black S150, Color Black S160, Color Black S170, PRINTEX 35, PRINTEX U, PRINTEX V, PRINTEX 140U, PRINTEX 140V, Special Black 6, Special Black 5, Special Black 4A and Special Black 4 (manufactured by Degussa Co.); and No. 25, No. 33, No. 40, No. 47, No. 52, No. 900, No. 2300, MCF-88, MA 600, MA 7, MA 8 and MA 100 (manufactured by Mitsubishi Chemical Co., Ltd.). However, the pigments are not restricted thereto.

Specific examples of the cyan color pigments include C.I. Pigment Blue-1, -2, -3, -15, -15:1, -15:2, -15:3, -15:4, -16, -22 and -60, but are not restricted thereto Specific examples of the magenta color pigments include C.I. Pigment Red-5, -7, -12, -48, -48:1, -57, -112, -122, -123, -146, -168, -177, -184, -202, and C.I. Pigment Violet -19, but are not restricted thereto.

Specific examples of the yellow color pigments include C.I. Pigment Yellow-1, -2, -3, -12, -13, -14, -16, -17, -73, -74, -75, -83, -93, -95, -97, -98, -114, 128, -129, -138, -151, -154 and -180, but are not restricted thereto.

Here, in the case where a pigment is used as the colorant, a pigment dispersing agent may be used in combination. Examples of usable pigment dispersing agents include a polymer dispersing agent, an anionic surfactant, a cationic surfactant, an amphoteric surfactant and a nonionic surfactant.

As the polymer dispersing agent, a polymer having both of a hydrophilic structure part and a hydrophobic structure part may be used. As the polymer having a hydrophilic structure part and a hydrophobic structure part, a condensation-type polymer and an addition polymer can be used. Examples of the condensation-type polymers include known polyester-based dispersing agents. Examples of the addition polymers include addition polymers of monomers having an α,β-ethylenically unsaturated group. By copolymerizing a monomer having an α,β-ethylenically unsaturated group with a hydrophilic group and a monomer having an α,β-ethylenically unsaturated group with a hydrophobic group, a desired polymer dispersing agent can be obtained. Further, a homopolymer of monomers having an α,β-ethylenically unsaturated group with a hydrophilic group can also be used.

Examples of the monomers having an α,β-ethylenically unsaturated group with a hydrophilic group include monomers having a carboxyl group, a sulfonic acid group, a hydroxyl group, a phosphoric acid group or the like; specifically, acrylic acid, methacrylic acid, crotonic acid, itaconic acid, itaconic acid monoester, maleic acid, maleic acid monoester, fumaric acid, fumaric acid monoester, vinyl sulfonic acid, styrene sulfonic acid, sulfonated vinyl naphthalene, vinyl alcohol, acrylamide, methacryloxy ethyl phosphate, bis(methacryloxy ethyl) phosphate, methacryloxy ethyl phenyl acid phosphate, ethylene glycol dimethacrylate, diethylene glycol dimethacrylate and the like.

Examples of the monomer having an α,β-ethylenically unsaturated group with a hydrophobic group include styrene derivatives such as styrene, α-methylstyrene and vinyl toluene, vinyl cyclohexane, vinyl naphthalene, vinyl naphthalene derivatives, alkyl acrylate, alkyl methacrylate, phenyl methacrylate, cycloalkyl methacrylate, alkyl crotonate, dialkyl itaconate, dialkyl maleate and the like.

Preferable examples of the copolymers used as a polymer dispersant include a styrene-styrene sulfonic acid copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene-acrylic acid copolymer, an alkyl acrylate-acrylic acid copolymer, an alkyl methacrylate-methacrylic acid copolymer, a styrene-alkyl methacrylate-methacrylic acid copolymer, a styrene-alkyl acrylate-acrylic acid copolymer, a styrene-phenyl methacrylate-methacrylic acid copolymer, and a styrene-cyclohexyl methacrylate-methacrylic acid copolymer. A monomer having a polyoxyethylene group or a hydroxyl group may also be copolymerized with the above polymers.

As the above-mentioned polymer dispersing agent have, for example, a weight average molecular weight of from 2,000 to 50,000.

These pigment dispersing agents may be used alone or in combination of two or more kinds. Although the addition amount of the pigment dispersing agent varies largely depending on the types of the pigments, the addition amount thereof is generally in the range of from 0.1% by weight to 100% by weight with respect to the amount of the pigment.

A pigment capable of self-dispersing in water can also be used as a colorant. The pigment capable of self-dispersing in water used in the present invention refers to the pigment that has a large number of water-solubilizing groups on the surface of the pigment and is capable of dispersing in water without the presence of a polymer dispersant. The pigment capable of self-dispersing in water is practically obtained by subjecting a common so-called pigment to surface modification treatments such as an acid or a base treatment, a coupling agent treatment, a polymer graft treatment, a plasma treatment or a redox treatment.

In addition to the above surface-modified pigments, commercially available pigments such as CAB-O-JET-200, CAB-O-JET-300, CAB-O-JET-250, CAB-O-JET-260, CAB-O-JET-270, IJX-444 and IJX-55 (manufactured by Cabot Corporation), and MICROJET BLACK CW-1 and CW-2 (manufactured by Orient Chemical Industries, Ltd.) may also be used as a pigment capable of self-dispersing in water.

The above self-dispersing pigments are preferably a pigment having at least a functional group of sulfonic acid, a sulfonate, a carboxylic acid, or a carboxylate on the surface thereof, and more preferably a pigment having a functional group of at least a carboxylic acid or a carboxylate on the surface thereof.

A pigment coated with a resin may also be used as the colorant. Such a pigment is called as a microcapsule pigment, which include commercially available microcapsule pigments manufactured by Dainippon Ink & Chemicals, Inc. and Toyo Ink MFG Co., Ltd. as well as the microcapsule pigments prepared for use in the invention.

A resin dispersing-type pigment composed of the above pigment to which a polymer substance is adsorbed or chemically bonded can also be used.

Other examples of the recording materials include dyes such as a hydrophilic anionic dye, direct dye, cationic dye, reactive dye, high molecular dye and oil-soluble dye, wax powder, resin powder or emulsions colored with a dye, fluorescent dye or fluorescent pigment, infrared absorber, ultraviolet absorber, magnetic materials such as ferromagnetic materials represented by ferrite, magnetite and others, semiconductors and photo catalysts represented by titanium oxide, zinc oxide and others, and other organic and inorganic particles of an electronic material.

The content (density) of the recording material is, for example, from 2% by weight to 20% by weight with respect to the amount of the ink.

The volume average particle size of the colorant is, for example, from 10 nm to 300 nm.

The volume average particle size of the colorant refers to the particle size of the colorant itself, or when an additive such as a dispersing agent is attached to the colorant, the particle size including the attached additive. In the invention, as the device for measurement of the volume average particle size, MICROTRUC UPA particle size analysis meter 9340 (produced by Leeds & Northrup Corp.) is used. The measurement is carried out according to the predetermined method with 4 ml of an ink put into a measuring cell. As the parameters to input for the measurement, the viscosity of the ink for an inkjet and the density of the recording material are used as the viscosity and the density of dispersed particles, respectively.

Next, a water-soluble organic solvent will be mentioned. As a water-soluble organic solvent, polyhydric alcohols, polyhydric alcohol derivatives, nitrogen-containing solvents, alcohols, sulfur-containing solvents, and the like may be used.

Specific examples of the polyhydric alcohols include sugar alcohols such as ethylene glycol, diethylene glycol, propylene glycol, butylene glycol, triethylene glycol, 1,5-pentane diol, 1,2-hexane diol, 1,2,6-hexane triol, glycerin, trimethylolpropane and xylitol; and saccharides such as xylose, glucose and galactose.

Specific examples of the polyhydric alcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and the ethylene oxide adduct of diglycerol.

Specific examples of the nitrogen-containing solvents include pyrrolidone, N-methyl-2-pyrrolidone, cyclohexyl pyrrolidone, and triethanol amine. Specific examples of the alcohols include ethanol, isopropyl alcohol, butyl alcohol and benzyl alcohol. Specific examples of the sulfur-containing solvents include thiodiethanol, thiodiglycerol, sulfolane, and dimethyl sulfoxide.

Propylene carbonates, ethylene carbonates, or the like may also be used as the water-soluble organic solvent.

The water-soluble organic solvent may be used one or more kinds thereof. The content of the water-soluble organic solvent to be used is, for example, from 1% by weight to 70% by weight.

Next, water will be explained. As the water, ion exchange water, ultra pure water, distilled water or ultrafiltrated water may be used in order to prevent introduction of impurities.

Next, other additives will be explained. A surfactant may be added to the ink.

As the surfactants, various kinds of anionic surfactants, nonionic surfactants, cationic surfactants, amphoteric surfactants and the like may be used, and the anionic surfactants and the nonionic surfactants are preferably used.

Specific examples of the anionic surfactants include an alkylbenzenesulfonate, alkylphenylsulfonate, alkylnaphthalenesulfonate, higher fatty acid salt, sulfuric acid ester salt of higher fatty acid ester, sulfonic acid salt of higher fatty acid ester, sulfuric acid ester salt and sulfonic acid salt of higher alcohol ether, higher alkylsulfosuccinate, polyoxyethylene alkyl ethercarboxylate, polyoxyethylene alkyl ethersulfate, alkylphosphate and polyoxyethylene alkyl etherphosphate, and dodecylbenzenesulfonate, isopropylnaphthalenesulfonate, monobutylphenylphenol monosulfonate, monobutylbiphenylsulfonate, monobutylbiphenylsulfonate and dibutylphenylphenoldisulfonate are preferably used.

Specific examples of the nonionic surfactants include polyoxyethylene alkyl ether, polyoxyethylene alkylphenyl ether, polyoxyethylene fatty acid ester, sorbitan fatty acid ester, polyoxyethylene sorbitan fatty acid ester, polyoxyethylene sorbitol fatty acid ester, glycerol fatty acid ester, polyoxyethyleneglycerol fatty acid ester, polyglycerol fatty acid ester, sucrose fatty acid ester, polyoxyethylene alkylamine, polyoxyethylene fatty acid amide, alkylalkanol amide, polyethyleneglycol polypropyleneglycol block copolymer, acetylene glycol and polyoxyethylene adduct of acetylene glycol, and polyoxyethylene adducts such as polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylol amide, polyethyleneglycol polypropyleneglycol block copolymer, acetylene glycol and polyoxyethylene adduct of acetylene glycol are preferably used.

In addition, silicone surfactants such as polysiloxane oxyethylene adducts, fluorine surfactants such as perfluoroalkyl carboxylate, perfluoroalkyl sulfonate and oxyethylene perfluoroalkyl ether, and biosurfactants such as spiculisporic acids, rhamnolipid and lysolecithin.

These surfactants may be used alone or in combination. The hydrophilicity/hydrophobicity balance (HLB) of the surfactant is preferably in the range of 3 to 20 in view of dissolvability or the like.

The amount of the surfactant to be added is preferably from 0.001% by weight to 5% by weight, and is more preferably from 0.01% by weight to 3% by weight.

Further, other various additives can be added to the ink, such as a permeating agent for adjusting permeating property of the ink, compounds such as polyethylene imine, polyamines, polyvinyl pyrrolidone, polyethylene glycol, ethyl cellulose and carboxy methyl cellulose, for controlling ink ejection property, and alkali metal compounds such as potassium hydroxide, sodium hydroxide and lithium hydroxide for adjusting conductivity and pH of the ink. As needed, a pH buffer, an antioxidant, a mildew preventing agent, a viscosity adjusting agent, a conductive agent, an ultraviolet ray absorbing agent, a chelating agent or the like can also be added.

Next, the properties of the ink will be explained. First, the pH of the ink is, for example, preferably not less than 7, more preferably in the range of from 7 to 11, and still more preferably in the range of from 8 to 10.

Here, the value of the pH of the ink as measured under ambient conditions of temperature of 23±0.5° C. and humidity of 55±5% R.H., using a pH/conductivity meter (MPC 227; manufactured by Mettler-Toledo International Inc.), is adopted.

The surface tension of the ink is, for example, 20 to 40 mN/m (preferably from 25 to 35 mN/m).

Here, the value as the surface tension is measured under the conditions of 23° C. and 55% RH by the use of a Willhermy type surface tensiometer (produced by Kyowa Interface Science Co., Ltd.) is used.

The ink viscosity may be, for example, from 3 mPa·s to 15 mPa·s., preferably 10 mPa·s to 10 mPa·s.

The viscosity here is determined as a value measured by using RHEOMAT 115 (manufactured by Contraves), at a measuring temperature of 23° C. and a shearing speed of 1400 s⁻¹.

The ink composition is not particularly limited to the above structure, and may include other functional materials than the recording material, such as a liquid crystal material or an electronic material.

(Ink Receiving Particle Storage Cartridge)

The ink receiving particle storage cartridge according to the present embodiment can be attached to and detached from a recording device, and is a member that stores the ink receiving particles according to the present embodiment described above, and that supplies the ink receiving particles to a particle application device (particle supply device) of the recording device.

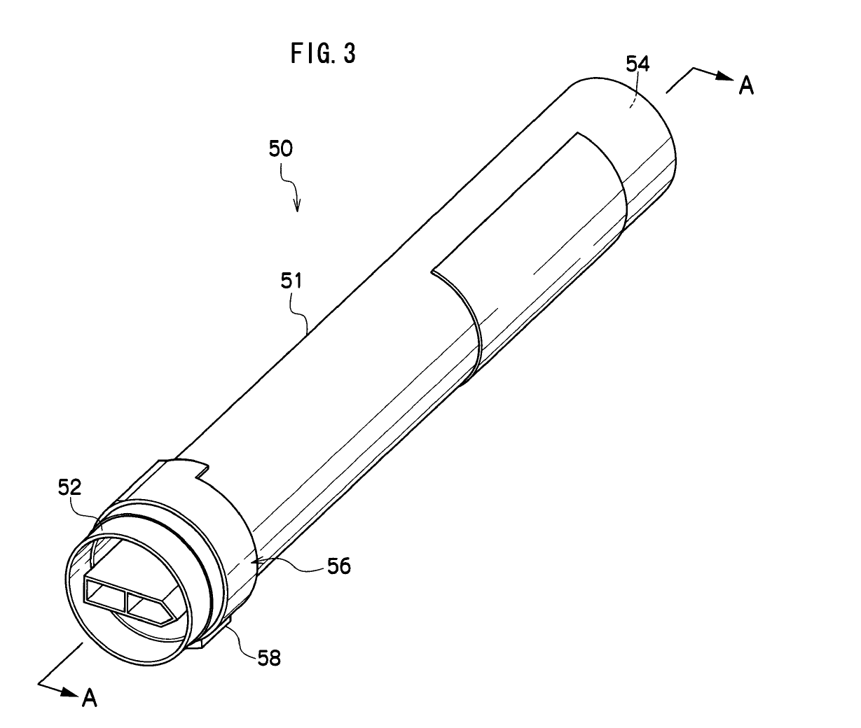

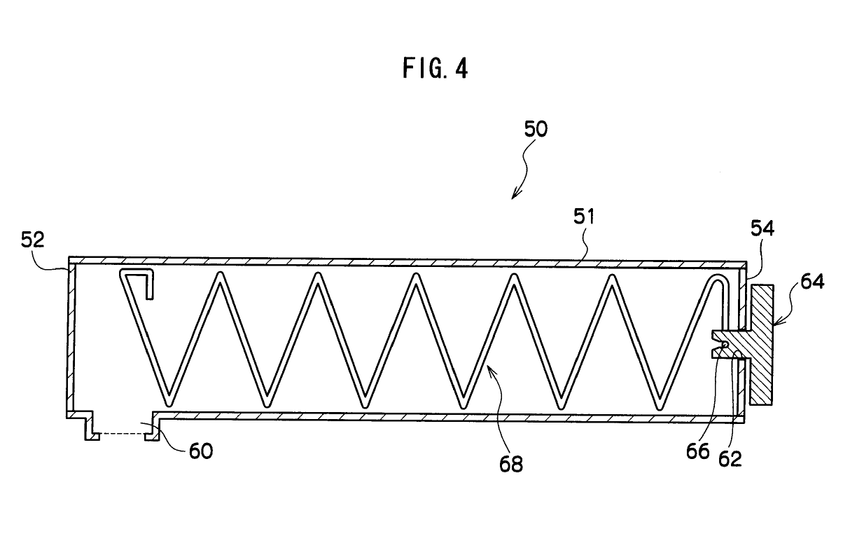

An exemplary embodiment of the ink receiving particle storage cartridge according to the present embodiment will be described below with reference to drawings. FIG. 3 is a perspective view showing the ink receiving particle storage cartridge according to an exemplary embodiment. FIG. 4 is a sectional view along A-A in FIG. 3.

As shown in FIG. 3 and FIG. 4, an ink receiving particle storage cartridge 50 according to the present embodiment is composed of a cylindrical particle storage cartridge main body 51, and side wall portions 52, 54 fitted to either end of the particle storage cartridge main body 51.

A discharge port 60 is provided at a peripheral surface at one end side of the particle storage cartridge main body 51, for ejecting ink receiving particles toward the particle application device (particle supply device, not shown) of the recording device. Further, a belt portion 56 is slidably attached to the particle storage cartridge main body 51. This belt portion 56 has a housing unit 58 that accommodates the discharge port 60 at the outer side of the discharge port 60.

Therefore, when the particle storage cartridge 50 is not loaded in the recording device (or immediately after it is loaded), the housing unit 58 accommodates the discharge port 60 so that the ink receiving particles inside the particle storage cartridge main body 51 do not leak from the discharge port 60.

A hole 62 is provided at the central portion of the side wall portion 54 at the other end side of the particle storage cartridge main body 51. A joining part 66 of a coupling 64 penetrates from the hole 62 of the side wall portion 54 into the inside of the particle storage cartridge main body 51. As a result, the coupling 64 is freely rotatable with respect to the side wall portion 54.

An agitator 68 is disposed inside the particle storage cartridge main body 51. The agitator 68 is a metal linear member made of, for example, stainless steel (SUS304W P), with a circular cross section, and formed in a spiral shape. Further, one end part of the agitator is bent in a vertical direction toward the rotary axis (center of rotation), and is coupled to the joining part 66 of the coupling 64. Additionally, the other end part is a free end, being free from restraint.

The agitator 68 receives torque from the joining part 66 of the coupling 64, and rotates, and conveys the ink receiving particles in the particle storage cartridge main body 51 toward the discharge port 60 while agitating the particles. Thus, by discharging the particles from the discharge port 60, the recording device can be additionally replenished with ink receiving particles

The ink receiving particle storage cartridge according to the present embodiment is not limited to the above configuration.

(Recording Device)

The recording device (recording method) of the present embodiment is a recording device (recording method) using an ink including a recording material and the ink receiving particles according to the present embodiment described above, and includes an intermediate transfer member, a supply unit that supplies the ink receiving particles onto the intermediate transfer member (supply process), an ink ejection unit that ejects ink toward the ink receiving particles that have been supplied onto the intermediate transfer member (ink ejection process), a transfer unit that transfers the ink receiving particles onto a recording medium (transfer process), and a fixing unit that fixes the ink receiving particles that have been transferred onto the recording medium (fixing process). In the recording device, the ink receiving particles are supplied onto the intermediate transfer member and receive ink ejected from the ink ejection unit (recording process).

Specifically, for example, first, the ink receiving particles are supplied from the supply unit onto an intermediate member (intermediate transfer member) in layer form. Ink is ejected from the ink ejection unit onto the ink receiving particles that have been supplied in layer form (hereinafter, ink receiving particle layer), and received. The ink receiving particle layer that has received the ink is transferred from the intermediate member onto the recording medium by the transfer unit. In the transfer, the entire ink receiving particle layer may be transferred, or a selected recording part (ink receiving part) may be transferred. The ink receiving particle layer transferred on the recording medium is pressed (or heated and pressed) and fixed by the fixing unit. Thus, the image is recorded by the ink receiving particles that have received the ink. In practice, transfer and fixing may be performed simultaneously or separately.

When receiving the ink, the ink receiving particles may form, for example, a layer, and the thickness of the ink receiving particle layer is, for example, in the range of 1 μm to 100 μm, preferably 3 μm to 60 μm, and more preferably 5 μm to 30 μm. The void ratio of ink receiving particle layer (that is, the ratio of voids between ink receiving particles+the ratio of voids inside the ink receiving particles (trap structure)) is, for example, 10% to 80%, preferably 30% to 70%, and more preferably 40% to 60%.

On the surface of the intermediate member, a releasing agent may be applied in advance prior to the supply of the ink receiving particles. Examples of the releasing agent include (modified) silicone oil, fluorine oil, hydrocarbon oil, mineral oil, vegetable oil, polyalkylene glycol, alkylene glycol ether, alkane diol, and fused wax.

The recording medium may be either a permeable medium (such as plain paper or coated paper) or an impermeable medium (such as art paper or resin film). The recording medium is not limited to these examples, and may include semiconductor substrate and other industrial products.

The recording device (recording method) of the present embodiment may includes a supply unit that supplies ink receiving particles onto a recording medium, an ink ejection unit that ejects ink toward the ink receiving particles that have been supplied onto the recording medium, and a fixing unit that fixes the ink receiving particles that have been supplied onto the recording medium and, in the recording device (recording method) the ink receiving particles may be supplied onto the recording medium, and receive ink ejected from the ink ejection unit.

Specifically, first, the ink receiving particles are supplied from the supply unit onto the recording medium in layer form. Ink is ejected from the ink ejection unit onto the ink receiving particles that have been supplied in layer form (hereinafter, ink receiving particle layer), and received. The ink receiving particle layer that has received the ink is pressed (or heated and pressed) and fixed by the fixing unit. Thus, the image is recorded by the ink receiving particles that have received the ink. As thus described, supplying of the ink receiving particles directly onto the recording medium is a possible configuration.

In the following, some exemplary embodiments of the invention will be described with reference to the drawings. Elements having substantially the same effects or functions are represented by the same reference marks in all of the drawings, and overlapping descriptions thereof may be omitted in some cases.

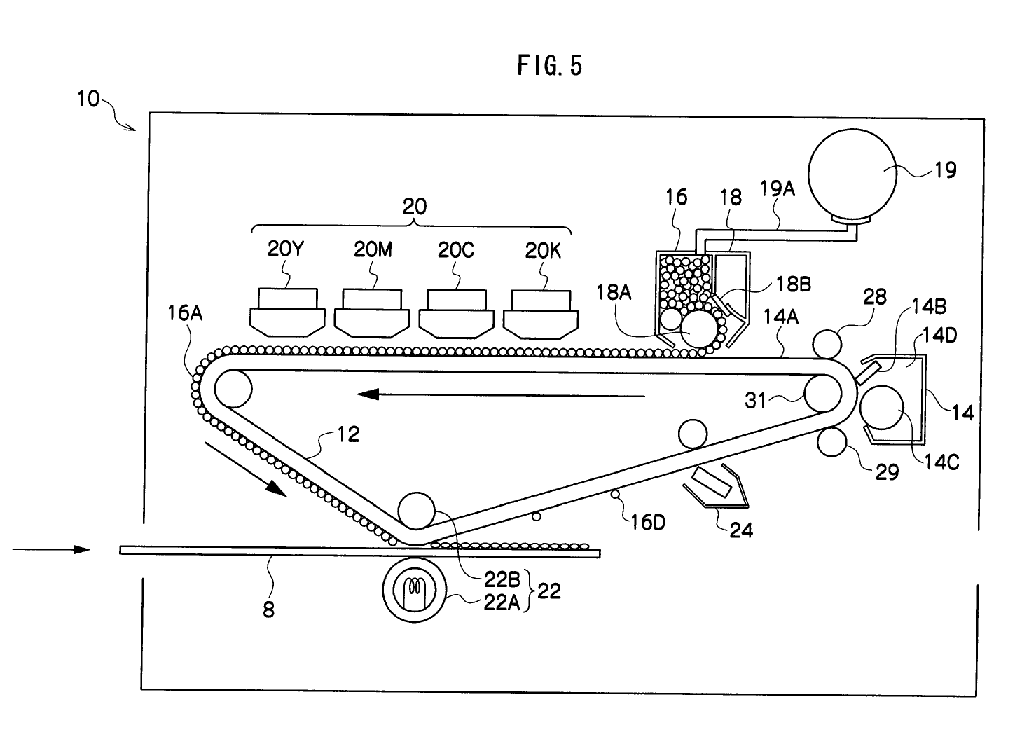

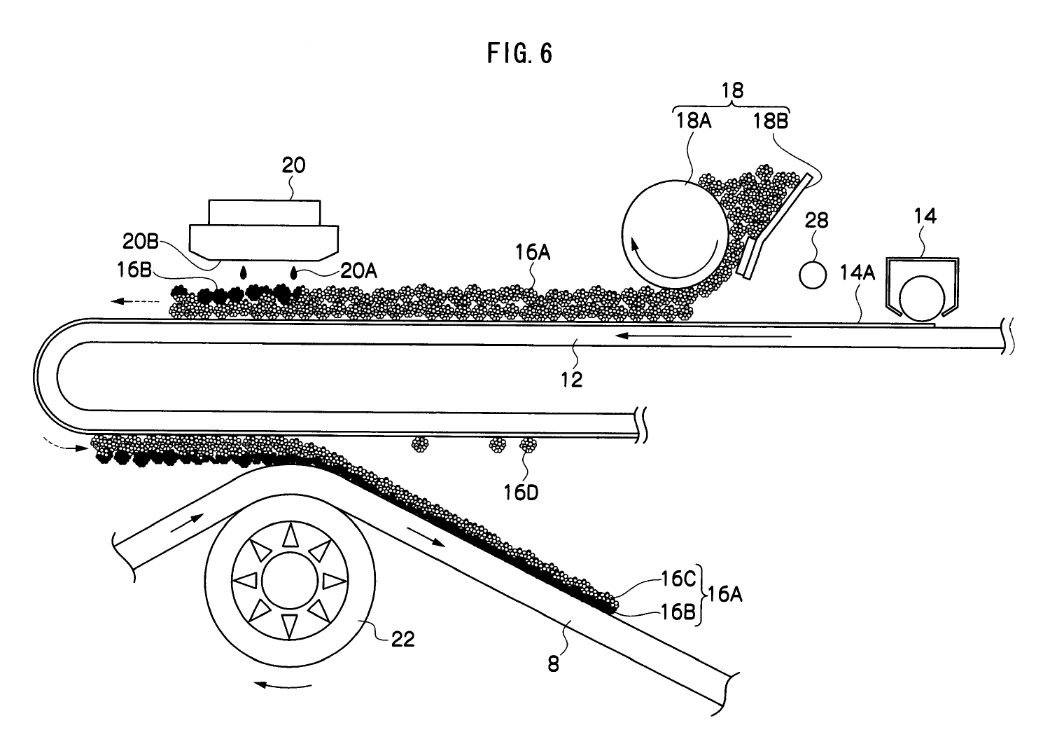

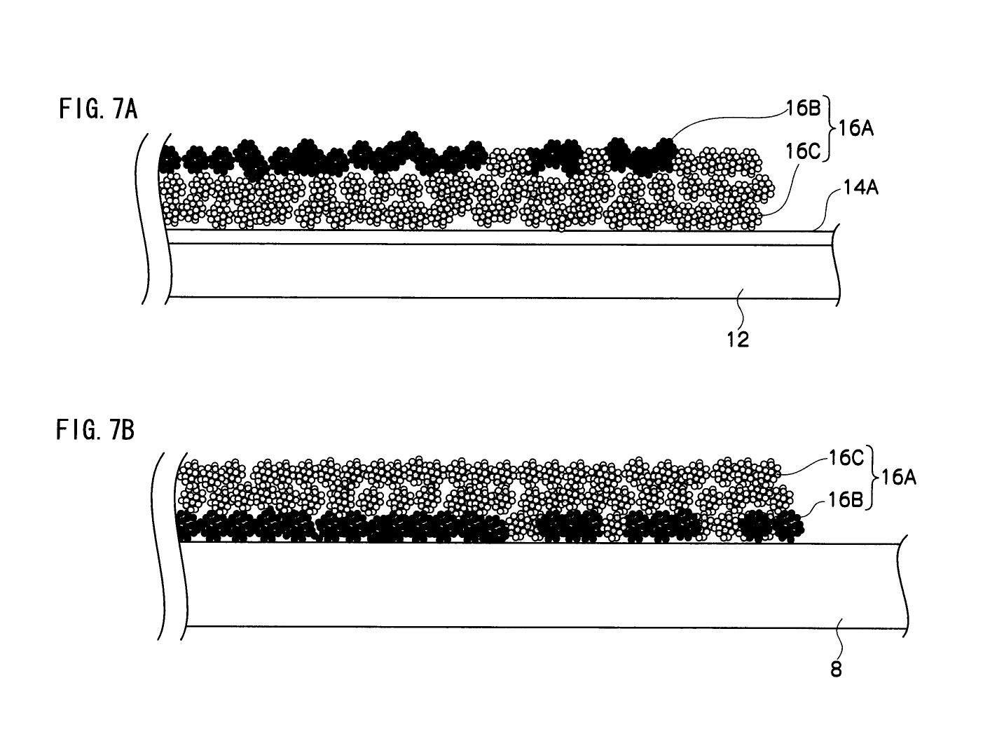

FIG. 5 is a configurational drawing showing a recording device according to an exemplary embodiment. FIG. 6 is a configurational drawing showing a main part of the recording device according to this exemplary embodiment. FIGS. 7A and 7B are configurational drawings showing ink receiving particle layers according to this exemplary embodiment. In the following exemplary embodiment, explanation will be given according to a case where composite particles are used as the ink receiving particles described later.

As shown in FIG. 5 and FIG. 6, a recording device 10 according to an exemplary embodiment includes an intermediate transfer member 12 in the form of an endless belt, a charging device 28 that charges the surface of the intermediate transfer member 12, a particle supply unit 18 that feeds ink receiving particles 16 to the charged area of the intermediate transfer member 12 to form a particle layer, an inkjet recording head 20 that ejects ink droplets onto the particle layer to form an image, and a transfer fixing unit 22 that transfers and fixes the layer of the ink receiving particles onto a recording medium 8 by contacting the intermediate transfer member 12 with the recording medium 8 and applying pressure and heat thereto. An ink receiving particle storage cartridge 19 is detachably connected to the particle supply unit 18 via a feed pipe 19A.

A releasing agent supply unit 14 that feeds a releasing agent 14D to form a releasing layer 14A is placed upstream of the charging device 28.

The particle supply unit 18 forms a layer of the ink receiving particles 16 on the surface of the intermediate transfer member 12 on which charges have been formed by the charging device 28. Ink droplets of the respective colors are ejected onto the particle layer from the inkjet recording heads 20, including the inkjet recording heads 20K, 20C, 20M, and 20Y for respective colors, thereby forming a color image.

The particle layer on the surface of which the color image layer has been formed is transferred onto the recording medium 8 by respective color image by the transfer fixing unit (transfer fixing roll) 22. At the downstream side of the transfer fixing unit 22, a cleaner 24 is disposed for removing ink receiving particles 16 remaining on the surface of intermediate transfer member 12, and for removing extraneous matter other than particles attached to the intermediate transfer member such as foreign matter (paper dust of the recording medium 8 or the like).

The recording medium 8 having the transferred color image is conveyed out, and charges are formed again on the surface of the intermediate transfer member 12 by the charging device 28. At this time, the ink receiving particles transferred onto the recording medium 8 absorb and retain the ink droplets 20A, thereby enabling speedy feeding out of the recording medium.

If necessary, a charge eraser 29 for erasing the charges left on the surface of the intermediate transfer member 12 may be placed between the cleaner 24 and the releasing agent supply unit 14 (hereinafter, the phrase “between A and B” indicates any position other than the positions for A and B, unless otherwise stated).

In this embodiment, the intermediate transfer member 12 includes a surface layer of 400 μm-thick ethylene-propylene rubber (EPDM) formed on a base layer made of a 1 mm-thick polyimide film. This surface layer preferably has a surface resistance of about 10¹³ Ω/square and a volume resistivity of about 10¹² Ω·cm (semiconductivity).

When the intermediate transfer member 12 is rotated, the releasing agent layer 14A is formed first on the surface of the intermediate transfer member 12 by the releasing agent supply unit 14. The releasing agent 14D is supplied onto the surface of the intermediate transfer member 12 by a feed roll 14C of the releasing agent supply unit 14, and the thickness of the releasing agent layer 14A is regulated by a blade 14B.

This structure may be such that the releasing agent supply unit 14 is in contact with the intermediate transfer member 12 in a continuous manner for the purpose of continuously performing image formation and printing, or that the releasing agent supply unit 14 is placed apart from the intermediate transfer member 12.

The releasing agent 14D may be supplied from an independent liquid supply system (not shown) to the releasing agent supply unit 14 so that the releasing agent 14D can be supplied in a continuous manner.

Next, positive charges are applied onto the surface of the intermediate transfer member 12 by the charging device 28 so that the surface of the intermediate transfer member 12 is positively charged. In this process, an electric potential is formed by which the ink receiving particles 16 can be supplied and adsorbed onto the surface of the intermediate transfer member 12, by means of an electrostatic force that can be generated between a feed roll 18A of the particle supply unit 18 and the surface of the intermediate transfer member 12.

In this embodiment, the device has such a structure that a voltage is applied by mean of the charging device 28 between the charging device 28 and a driven roll 31 (connected to the ground) that is placed opposite to the charging device 28 via the intermediate transfer member 12, thereby charging the surface of the intermediate transfer member 12.

The charging device 28 is a roll-shaped component that includes a rod-shaped stainless steel material and an elastic layer in which an electrical conductivity-imparting material is dispersed (a urethane foam resin) formed on the surface of the rod-shaped material, and has a volume resistivity regulated to be from about 10⁶ Ω·cm to about 10⁸ Ω·cm. In addition, the surface of the elastic layer is covered with a water- and oil-repellant coating layer (for example, made of a tetrafluoroethylene-perfluoroalkyl vinyl ether copolymer (PFA)) to a thickness of 5 μm or more and 100 μm or less.

The charging device 28 is connected to a DC power source, and the driven roll 31 is electrically connected to the frame ground. The charging device 28 is driven while holding the intermediate transfer member 12 between the driven roll 31 and the charging device 28. At the pressing site, a predetermined degree of potential difference is generated between the charging device 28 and the grounded driven roll 31, by which charges can be applied to the surface of the intermediate transfer member 12. In this embodiment, for example, the surface of the intermediate transfer member 12 is charged by applying a voltage of 1 kV onto the surface of the intermediate transfer member 12 by the charging device 28.

The charging device 28 may be a corotron or the like.

The ink receiving particles 16 are then fed from the particle supply unit 18 to the surface of the intermediate transfer member 12 to form an ink receiving particle layer 16A. The particle supply unit 18 includes, in a vessel storing the ink receiving particles 16, a feed roll 1 8A placed opposite to the intermediate transfer member 12 and a charging blade 18B placed so as to apply pressure to the feed roll 18A. The charging blade 18B also have the function of controlling the thickness of the layer formed by ink receiving particles 16 supplied onto the surface of the feed roll 18A.

When the ink receiving particles 16 are supplied to the feed roll 18A (conductive roll), the ink receiving particle layer 16A is regulated by the charging blade 18B (conductive blade) and is negatively charged, i.e., provided with the polarity opposite to that of the charges on the surface of the intermediate transfer member 12. For example, an aluminum solid roll may be used as the feed roll 18A, and a metal plate (such as a SUS plate) with a urethane rubber for pressing may be used as the charging blade 18B. The charging blade 18B is in contact with the feed roll 18A by a doctor blade method.

The charged ink receiving particles 16 form a particle layer consisting of, for example, a single layer, on the surface of the feed roll 18A and are delivered to a site facing the surface of the intermediate transfer member 12, and are then transferred onto the surface of the intermediate transfer member 12 by an electrostatic force formed by the electric field generated by the potential difference between the feed roll 18A adjacent to the above site and the surface of the intermediate transfer member 12.

In this process, the traveling speed of the intermediate transfer member 12 and the rotating speed of the feed roll 18A (the peripheral speed ratio) are relatively set such that a single layer of particles is formed on the surface of the intermediate transfer member 12. The peripheral speed ratio depends on the amount of the charges on the intermediate transfer member 12, the amount of the charges on the ink receiving particles 16, the positional relationship between the feed roll 18A and the intermediate transfer member 12, or other parameters.

By relatively increasing the peripheral speed of the feed roll 18A with reference to the peripheral speed ratio at which a single ink receiving particle layer 16A is formed, the amount of the particles supplied onto the intermediate transfer member 12 can be increased. If the density of the transferred image is low (the ejecting amount of the ink is small; for example, 0.1 g/m² or more and 1.5 g/m² or less), the layer thickness is preferably minimized; for example, 1 μm or more and 5 μm or less). If the image density is high (the ejection amount of the ink is large; for example, 4 g/m² or more and 15 g/m² or less), the layer thickness is preferably regulated to be a sufficient level for retaining a liquid ink component, e.g., a solvent or a dispersion medium (for example, 10 μm or more and 25 μm or less).

For example, in a case where a character or image is printed with a small ejecting amount of the ink, when an image is formed onto a single ink receiving particle layer on the intermediate transfer member, the image-forming material (pigment) in the ink is trapped on the surface of the ink receiving particle layer on the intermediate transfer member, and is fixed on the surface of the ink receiving particles or in interparticle voids thereof, so that the distribution of the ink in the depth direction is reduced.

For example, when a particle layer 16C is desired as a protective layer on an image layer 16B that will become a final image, the ink receiving particle layer 16A can be formed to a thickness of about three layers and an image is formed with ink on the uppermost layer (see FIG. 7A). In this way, the particle layer 16C of two layers having no image will form a protective layer on the image layer 16B after being transferred and fixed on a recording medium (see FIG. 7B).

When an image is formed with a large ejecting amount of ink, such as an image including secondary or tertiary colors, the ink receiving particles 16 are layered so that there are enough particles to retain a liquid ink component (e.g., a solvent or a dispersion medium), thereby trapping the recording material (e.g., a pigment) to prevent it from reaching the bottom layer. In this case, the ink receiving particles 16 having no image can form a protective layer on the surface of the image after being transferred and fixed, so that the image-forming material (pigment) is not exposed on the surface of the image.

The inkjet recording head 20 then applies ink droplets 20A onto the ink receiving particle layer 16A. The inkjet recording head 20 applies the ink droplets 20A onto a predetermined location according to the given image information.

Finally, the recording medium 8 and the intermediate transfer member 12 are nipped by the transfer fixing unit 22, and pressure and heat are applied to the ink receiving particle layer 16A to transfer it onto the recording medium 8.

The transfer fixing unit 22 includes a heating roll 22A containing a heat source and a pressing roll 22B facing the heating roll 22A via the intermediate transfer member 12, and a contact portion is formed between the heating roll 22A and the pressing roll 22B. An aluminum core coated with a silicone rubber and further coated with a PFA tube, for example, can be used as the heating roll 22A and the pressing roll 22B.

At the contact portion formed between the heating roll 22A and the pressing roll 22B, the ink receiving particle layer 16A is heated by a heater and pressure is applied, and therefore the ink receiving particle layer 16A is transferred and fixed onto the recording medium 8.

In this process, resin particles of the ink receiving particles 16 in the non-image area are heated to a temperature of not less than the glass transition temperature (Tg) to be softened (or melted), and the ink receiving particle layer 16A is released from the releasing layer 14A that has been formed on the surface of the intermediate transfer member 12 by pressure, and transferred and fixed onto the recording medium 8. In this process, the transfer fixing ability can be improved by heating. In this embodiment, the temperature of the surface of the heating roll 22A is controlled to be 160° C. In this process, the liquid ink component (a solvent or a dispersion medium) is retained in the ink receiving particle layer 16A even after the transfer, and is fixed. Further, the intermediate transfer member 12 may be pre-heated before entering to the transfer fixing unit 22.

Additionally, either of a permeable medium (for example, plain paper or inkjet coat paper) or a non-permeable medium (for example, art paper or resin film) may be employed as the recording medium 8. Further, the recording medium is not limited thereto and, in addition, includes industrial products such as a semiconductor substrate.

The process of forming an image in the recording device according to this embodiment will be described in more detail below. As shown in FIG. 6, the releasing layer 14A may be formed on the surface of the intermediate transfer member 12 by the releasing agent supply unit 14 in the recording device according to this embodiment. When the base material of the intermediate transfer member 12 is aluminum- or PET-based, the releasing layer 14A may be formed. Alternatively, the surface of the intermediate transfer member 12 in itself may have a releasing ability by using a material of fluoropolymer- or silicone rubber-based.

The surface of the intermediate transfer member 12 is then charged by the charging device 28 to be polarized oppositely to that of the ink receiving particles 16. Thus, the ink receiving particles 16 supplied from the feed roll 18A of the particle supply unit 18 can be electrostatically adsorbed to form a layer of the ink receiving particles 16 on the surface of the intermediate transfer member 12.

The layer of ink receiving particles 16 are then formed on the surface of the intermediate transfer member 12 by means of the feed roll 18A of the particle supply unit 18. For example, the ink receiving particle layer 16A is formed to a thickness of about three layers of the ink receiving particles 16. Specifically, the thickness of the ink receiving particle layer 16A is regulated to a desired degree by the gap between the feed roll 18A and the charging blade 18B, thereby controlling the thickness of the ink receiving particle layer 16A to be transferred to the recording medium 8. Alternatively, the thickness may be controlled by the ratio of the peripheral speeds of the feed roll 18A and the intermediate transfer member 12.

The ink droplets 20A are then ejected onto the formed ink receiving particle layer 16A by the inkjet recording heads 20 of respective colors, driven in a piezoelectric mode, a thermal mode or the like, to form the image layer 16B on the ink receiving particle layer 16A. The ink droplets 20A are ejected from the inkjet recording head 20 into the ink receiving particle layer 16A, and the liquid component of the ink is rapidly absorbed into the voids among the ink receiving particles 16 and into the voids within the ink receiving particles 16, and at the same time, the recording material (such as a pigment) is also trapped on the surface of the ink receiving particles 16 (constituent particles) or in the interparticle voids in the constituent particles of the ink receiving particles 16.

In this process, while the ink liquid component (a solvent or a dispersion medium) in the ink droplets 20A penetrates into the ink receiving particle layer 16A, the recording material such as a pigment is trapped on the surface of the ink receiving particle layer 16A or in the interparticle voids thereof. In other words, the ink liquid component (a solvent or a dispersion medium) may be allowed to pass through to the back side of the ink receiving particle layer 16A, whereas the recording material such as a pigment is not. Thus, in the process of transferring an image to the recording medium 8, a particle layer 16C to which the recording materials such as a pigment is formed on an image layer 16B. As a result, the particle layer 16C forms a protective layer that seals the surface of the image layer 16B, and an image having a surface on which no recording material is exposed can be formed.

The ink receiving particle layer 16A having the image layer 16B formed thereon is then transferred and fixed from the intermediate transfer member 12 onto the recording medium 8, thereby forming a color image on the recording medium 8. The ink receiving particle layer 16A on the intermediate transfer member 12 is heated and pressed by the transfer fixing unit (a transfer fixing roll) 22 that is heated by a heating part such as a heater, and is transferred onto the recording medium 8.

In this process, the surface irregularities of the image and the glossiness may be regulated by controlling the heating and pressing conditions. Alternatively, the glossiness can be controlled by performing cool separation.

After the ink receiving particle layer 16A has been separated, the residual particles 16D on the surface of the intermediate transfer member 12 are collected by the cleaner 24 (see FIG. 5), and the surface of the intermediate transfer member 12 is charged again by the charging device 28, and the ink receiving particles 16 are supplied thereon to form an ink receiving particle layer 16A.

FIG. 7 shows particle layers used in the image formation according to the invention. As shown in FIG. 7A, the releasing layer 14A is formed on the surface of the intermediate transfer member 12.

The ink receiving particles 16 is then formed into one or more layers on the surface of the intermediate transfer member 12, by means of the particle supply unit 18. As described above, the ink receiving particles 16 may be stacked in about three layers in a thickness direction of the ink receiving particle layer 16A. The thickness of the ink receiving particle layer 16A to be transferred onto the recording medium 8 is regulated by controlling the ink receiving particle layer 16A to a desired thickness. In this process, the surface of the ink receiving particle layer 16A is smoothed so that image formation (formation of the image layer 16B) by ejecting ink droplets can be performed without problems.

As shown in FIG. 7A, a recording material such as a pigment contained in the ejected ink droplets 20A penetrates into the ink receiving particle layer 16A to an amount of about ⅓ to about half of the total thickness thereof, and under the ink receiving particle layer 16A remains the particle layer 16C into which no recording material such as a pigment has not penetrated.

As shown in FIG. 7B, the ink receiving particle layer 16A formed on the recording medium 8 by heat/press transfer at the transfer fixing unit (transfer fixing roll) 22 includes the image layer 16B and the ink-free particle layer 16C on the image layer 16B, and the layer 16C serves as a kind of protective layer to prevent the image layer 16B from being directly exposed on the surface. Therefore, the ink receiving particles 16 need to be transparent at least after fixation.

The particle layer 16C is heated and pressed by the transfer fixing unit (transfer fixing roll) 22 so that its surface can be smoothed, and also the glossiness of the image surface can be controlled by heating or pressing.

Further, evaporation of the liquid ink component (a solvent or a dispersion medium) trapped in the ink receiving particles 16 may be enhanced by heating.

The liquid ink component (a solvent or a dispersion medium) that has been received and retained in the ink receiving particle layer 16A remains in the ink receiving particle layer 16A even after the transfer and fixing, and is then removed by air drying.

The image formation is completed via the above-mentioned processes. As regards the intermediate transfer member 12, when, after the ink receiving particles 16 have been transferred to the recording medium 8, the residual particles 16D remain on the intermediate transfer member 12 or a foreign matter such as paper powder separated from the recording medium 8 is present, these may be removed by the cleaner 24.

A charge eraser 29 may be disposed downstream of the cleaner 24. For example, an electrically conductive roll is used as the charge eraser 29, and the intermediate transfer member 12 is interposed between the electrically conductive roll and a driven roll 31 (grounded), and then a voltage of approximately ±3 kV and 500 Hz is applied to the surface thereof to erase electric charge from the surface of the intermediate transfer member 12.

The charging voltage, the thickness of the particle layer, the fixing temperature and other various conditions for the device may be optimized, respectively, depending on the composition of the ink receiving particles 16 or the ink, the amount of the ink to be ejected, and the like.

<Constituent Elements>

Constituent elements for each step of the embodiment will be described in detail below.

<Intermediate Transfer Member>

The intermediate transfer member 12 on which the ink receiving particle layer is formed may be in the form of a belt as shown in the embodiment, or in the form of a cylinder (a drum). In order to supply and retain the ink receiving particles on the surface of the intermediate transfer member by electrostatic force, the outer surface of the intermediate transfer member needs to have semiconductive or insulating particle-retention properties. When the electrical properties of the surface of the intermediate transfer member is semiconductive, a material with a surface resistivity of 10¹⁰ Ω/square or more and 10¹⁴ Ω/square or less and a volume resistivity of 10⁹ Ω·cm or more and 10¹³ Ω·cm or less is used, and when the electrical properties of the surface of the intermediate transfer member is insulating, a material with a surface resistivity of 10¹⁴ Ω/square or more and a volume resistivity of 10¹³ Ω·cm or more can be used.

When the intermediate transfer member is in the form of a belt, any material can be used for the base material, as long as the material is capable of belt rotation driving in an apparatus and has necessary mechanical strength, and when heat is applied for transfer and fixing, necessary heat resistance. Specifically, polyimide, polyamideimide, aramid resins, polyethylene terephthalate, polyester, polyethersulfone, stainless steel, or the like may be used.

When the intermediate transfer member is in the form of a drum, the base material may be aluminum, stainless steel or the like.

When the heating method is performed by electromagnetic induction in the fixing process with the transfer fixing unit (transfer fixing roll) 22, a heat generating layer may be formed on the intermediate transfer member 12 instead of on the transfer fixing unit (transfer fixing roll) 22. A metal capable of causing electromagnetic induction may be used for the heat generating layer, which may be selected from nickel, iron, copper, aluminum, chromium, and the like.

<Particle Supply Process>

Prior to supplying the ink receiving particles 16, the releasing layer 14A is formed with the releasing agent 14D supplied from the releasing agent supply unit 14 on the surface of the intermediate transfer member 12.

The releasing layer 14A may be formed by a method including feeding the releasing agent 14D, from a releasing agent supply unit that stores the releasing agent 14D, to the surface of the intermediate transfer member 12 to form the releasing layer 14A, or by a method including forming the releasing layer 14A on the surface of the intermediate transfer member 12 using a supplying member that has been impregnated with the releasing agent 14D.

Examples of the releasing agent 14D include releasing materials such as silicone-based oil, fluorine-based oil, polyalkylene glycol, and surfactants.

Examples of the silicone-based oil include straight silicone oil and modified silicone oil.

Examples of the straight silicone oil include dimethyl silicone oil and methylhydrogen silicone oil.

Examples of the modified silicone oil include methylstyryl modified oil, alkyl modified oil, higher fatty acid ester modified oil, fluorine modified oil, and amino modified oil.

Examples of polyalkylene glycol include polyethylene glycol, polypropylene glycol, ethylene oxide-propylene oxide copolymer, and polybutylene glycol; however, polypropylene glycol is preferable among these.

Examples of the surfactants include anionic surfactants, cationic surfactants, amphoteric surfactants, and nonionic surfactants; however, among these, nonionic surfactants are preferable.

The viscosity of the releasing agent 14D is, for example, preferably from 5 mPa·s to 200 mPa·s, more preferably from 5 mPa·s to 100 mPa·s, and still more preferably from 5 mPa·s to 50 mPa·s.

The measurement of the viscosity is conducted as follows. The viscosity of the obtained ink was measured using a RHEOMAT 115 (manufactured by Contraves) as the measurement device. The measurement was performed by putting a sample into a measurement container and loading it into the device according to a given method, and then measuring at a measuring temperature of 40° C., and a shearing speed of 1400 s⁻¹.

The surface tension of the releasing agent 14D is, for example, in the range of not more than 40 mN/m (preferably not more than 30 mN/m, and more preferably not more than 25 mN/m).

Here, measurement of the surface tension is performed as follows. With ambient conditions of 23±0.5° C., and 55±5% R.H. the surface tension of an obtained sample is measured using a Willhermy type surface tensiometer (manufactured by Kyowa Kaimen Kagaku Corp.).

The boiling point of the releasing agent 14D is, for example, not less than 250° C. (preferably not less than 300° C., and more preferably not less than 350° C.) under the pressure of 760 mmHg.

Additionally, the measurement of the boiling point is conducted as follows. The measurement is conducted in accordance with JIS K2254, the disclosure of which is incorporated by reference herein, and the initial distillation point is used as the boiling point.

Subsequently, the surface of the intermediate transfer member 12 is electrically charged to a reverse polarity to the polarity of the ink receiving particles 16, by means of a charging device 28. Then, an ink receiving particle layer 16A is formed at the surface of the charged intermediate transfer member 12. A general method for supplying electrophotographic toners onto a photoreceptor may be applied as the method for forming the ink receiving particle layer 16A. In other words, electrical charge is supplied in advance to the surface of the intermediate transfer member 12 in accordance with a general electrophotographic charging process (electric charging by the charging device 28 or the like). The ink receiving particles 16 are frictionally charged (one-component frictional charging system or two-component system) with the reverse polarity to the polarity of the surface of the intermediate transfer member 12.

The ink receiving particles 16 held on the feed roll 18A form an electric field with the surface of the intermediate transfer member 12, and are transferred and supplied onto the intermediate transfer member 12 and held there by electrostatic force. In this process, the thickness of the ink receiving particle layer 16A may be controlled depending on the thickness of the image layer 16B formed as a part of the ink receiving particle layer 16A (depending on the amount of the ink to be ejected). In this process, the absolute value of the amount of the charge of the ink receiving particles 16 is preferably in the range of 5 μc/g or more and 50 μc/g or less.

In this process, the thickness of the ink receiving particle layer 16A is preferably 1 μm or more and 100 μm or less, more preferably 1 μm or more and 50 μm or less, and still more preferably 5 μm or more and 25 μm or less. The porosity of the ink receiving particle layer (i.e., the sum of the void ratio in the ink receiving particles and the void ratio in the ink receiving particles (trap structure)) is preferably 10% or more and 80% or less, more preferably 30% or more and 70% or less, and still more preferably 40% or more and 60% or less.

Here, a particle supply process corresponding to a single-component supply (development) method will be described.

The ink receiving particles 16 are supplied to the feed roll 18A, then charged and the thickness thereof is regulated by the charging blade 18B.

The charging blade 18B has a function to regulate the thickness of the layer of the ink receiving particles 16 formed on the surface of the feed roll 18A. For example, the charging blade 18B can change the layer thickness of the ink receiving particles 16 on the surface of the feed roll 18A by changing the pressure applied to the feed roll 18A. For example, by forming a single layer of the ink receiving particles 16 on the surface of the feed roll 18A, the layer of the ink receiving particles 16 on the surface of the intermediate transfer member 12 may be made in the form of a single layer. Alternatively, by setting the pressing force of the charging blade 18B to a low level, the thickness of the layer of the ink receiving particles 16 formed on the surface of the feed roll 18A can be increased, and thus the thickness of the ink receiving particle layer formed on the surface of the intermediate transfer member 12 can be increased.

A method can also be mentioned in which, for example, when the peripheral speeds of the feed roll 18A and the intermediate transfer member 12 are defined as 1 respectively, at which a single particle layer is formed on the surface of the intermediate transfer member 12, the thickness of the layer of the ink receiving particles 16 can be increased by increasing the peripheral speed of the feed roll 18A to increase the amount of the ink receiving particles 16 supplied onto the surface of the intermediate transfer member 12. Further, these methods may be combined to control the layer thickness. In the configuration as described above, for example, the ink receiving particles 16 are negatively charged, and the intermediate transfer member 12 is positively charged.

By controlling the thickness of the ink receiving particle layer in such a manner, a pattern having a protective layer coating the surface of the pattern can be formed with reduced consumption of ink receiving particles.

The charging roll in the charging device 28 may be a bar- or pipe-shaped member made of aluminum, stainless steel or the like having an elastic layer formed on the outer surface thereof, the elastic layer containing a conductivity-imparting material dispersed therein, and the roll having a diameter of 10 mm or more and 25 mm or less and a volume resistivity that is controlled to be about 10⁶ Ω·cm or more and about 10⁸ Ω·cm or less.

The elastic layer can be formed using urethane resins, thermoplastic elastomers, epichlorohydrin rubbers, ethylene-propylene-diene copolymer rubbers, silicone rubbers, acrylonitrile-butadiene copolymer rubbers, polynorbornene rubbers, and any other resin materials. These materials may be used alone or in combination of two or more, and a urethane foam resin may be used.

The urethane foam resin may be a urethane resin containing a hollow material such as hollow glass beads and thermally expandable microcapsules mixed and dispersed therein to have a closed-cell structure.

The surface of the elastic layer may be covered with a water-repellant coating layer with a thickness of 5 μm or more and 100 μm or less.

The charging device 28 is connected to a DC power source, and the driven roll 31 is electrically connected to the frame ground. The charging device 28 is driven while holding the intermediate transfer member 12 between the charging device 28 and the driven roll 31, and a predetermined potential difference is generated between the charging device 28 and the grounded driven roll 31 at the pressing site.

<Marking Process>

An image is formed by ejecting the ink droplets 20A from the inkjet recording head 20 onto the layer of the ink receiving particles 16 (ink receiving particle layer 16A) which has been formed on the surface of the intermediate transfer member 12, according to an image signal. The ink droplets 20A are ejected into the ink receiving particle layer 16A from the inkjet recording head 20, and are rapidly absorbed into the interparticle voids formed in the ink receiving particles 16, while the recording material (such as a pigment) is trapped on the surface of the ink receiving particles 16 or in the interparticle voids of the ink receiving particles 16.

In this case, a large amount of the recording material (such as a pigment) may be trapped on the surface of the ink receiving particle layer 16A. The interparticle voids in the ink receiving particles 16 exhibit a filter effect so that the recording material (such as a pigment) is trapped on the surface of the ink receiving particle layer 16A, and is trapped and fixed in the interparticle voids in the ink receiving particles 16.

In order to ensure the trapping of the recording material (such as a pigment) on the surface of the ink receiving particle layer 16A and in the interparticle voids in the ink receiving particles 16, a method may be applied in which the ink is allowed to react with the ink receiving particles 16 to rapidly insolubilize (aggregate) the recording material (such as a pigment). Specifically, a reaction between the ink and a polyvalent metal salt or a pH reaction type may be applied to the above reaction.

The inkjet recording head may be a line-type inkjet recording head having a width equal to or larger than the width of the recording medium. However, an image may also be formed on a particle layer formed on an intermediate transfer member in a sequential manner using a conventional scanning-type inkjet recording head. The parts for ejecting ink of the inkjet recording head 20 may be any one as long as it is capable of ejecting ink, such as a piezoelectric element-driving type or a heating element-driving type. Conventional inks containing a dye as a colorant may be used for the ink, but an ink containing a pigment may be used.

When reacting the ink receiving particles 16 with an ink, the ink receiving particles 16 is treated with an aqueous solution containing a coagulant (for example, a polyvalent metal salt or an organic acid) having an effect of coagulating a pigment by the reaction of the coagulant with the ink, and dried.

<Transfer Process>

The ink receiving particle layer 16A having received the ink droplets 20A and having been formed with an image is transferred and fixed onto the recording medium 8 so that the image is formed on the recording medium 8. The transfer and the fixing may be performed separately, but may be performed substantially simultaneously. The fixing may be performed by a method of heating the ink receiving particle layer 16A or a method of pressing it, or a method including both heating and pressing, but may be performed by a method of performing heating and pressing substantially simultaneously.

By controlling the heating and pressing, physical properties and glossiness at the surface of the ink receiving particle layer 16A can be controlled. After the heating and pressing, the recording medium 8 having the image (ink receiving particle layer 16A) transferred thereon may be separated from the intermediate transfer member 12 after cooling the ink receiving particle layer 16A. The cooling may be performed by natural cooling or forced cooling such as air cooling. For these processes, the intermediate transfer member 12 may be used in the form of a belt.

The ink image is preferably formed on a surface part of the layer of the ink receiving particles 16 formed on the intermediate transfer member 12 (the recording material (pigment) is trapped on the surface of the ink receiving particle layer 16A) so that the ink image is protected by the particle layer 16C of the ink receiving particles 16, when transferred onto the recording medium 8.

The liquid ink component (a solvent or a dispersion medium) that has been received and retained by the layer of the ink receiving particles 16 is maintained in the layer of the ink receiving particles 16 even after the transfer and the fixing, and is then removed by air drying.

<Cleaning Process>

To allow repeated use by refreshing the surface of intermediate transfer member 12, a process of cleaning the surface by the cleaner 24 may be carried out. The cleaner 24 includes a cleaning part and a recovery part for conveying particles (not shown), and by the cleaning process, the ink receiving particles 16 (residual particles 16D) remaining on the surface of intermediate transfer member 12, and extraneous matter other than particles attached to the surface of intermediate transfer member 12 such as foreign matter (paper dust of the recording medium 8 and the like) can be removed. The recovered residual particles 16D may be reused.

<Charge Erasing Process>

The surface of the intermediate transfer member 12 may be subjected to charge erasing using the charge eraser 29 prior to forming the releasing layer 14A.

In the recording device according to this embodiment described above, the surface of the intermediate transfer member 12 is charged by the charging device 28 after supplying the releasing agent 14D from the releasing agent supply unit 14 to the surface of the intermediate transfer member 12 to form the releasing layer 14A. The ink receiving particles 16 are then supplied from the particle supply unit 18 to the region where the releasing layer 14A has been formed and charged of the intermediate transfer member 12, thereby forming a particle layer. Thereafter, ink droplets are ejected from the inkjet recording head 20 onto the particle layer to form an image, and the ink is received by the ink receiving particles 16. The recording medium 8 is then superposed onto the intermediate transfer member 12, pressed and heated by the transfer fixing unit 22, and thus the ink receiving particle layer is transferred and fixed onto the recording medium 8.

The recording device is not limited to the intermediate transfer system configuration and may have another configuration in which the ink receiving particles are supplied directly onto the recording medium, as described below.

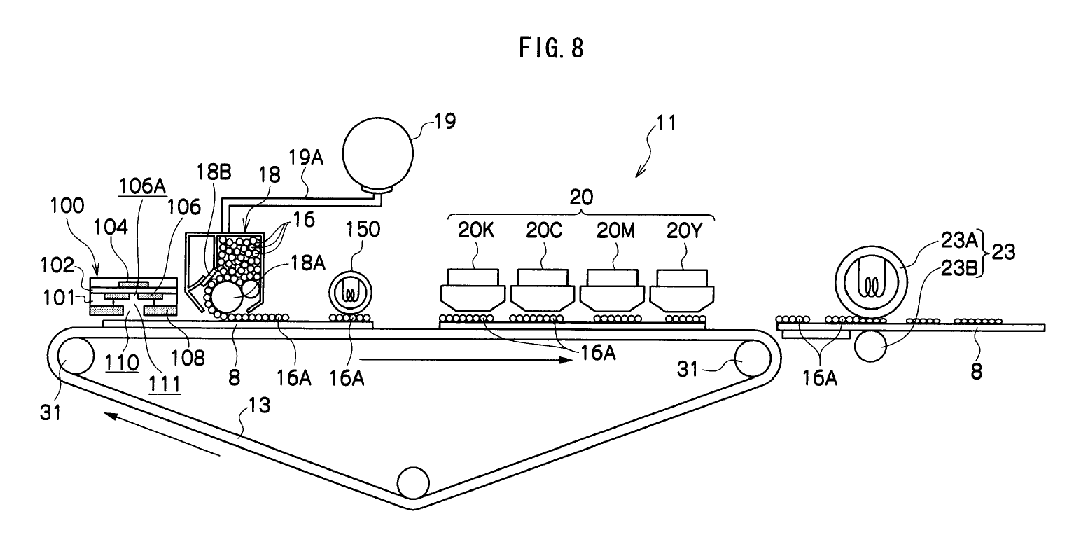

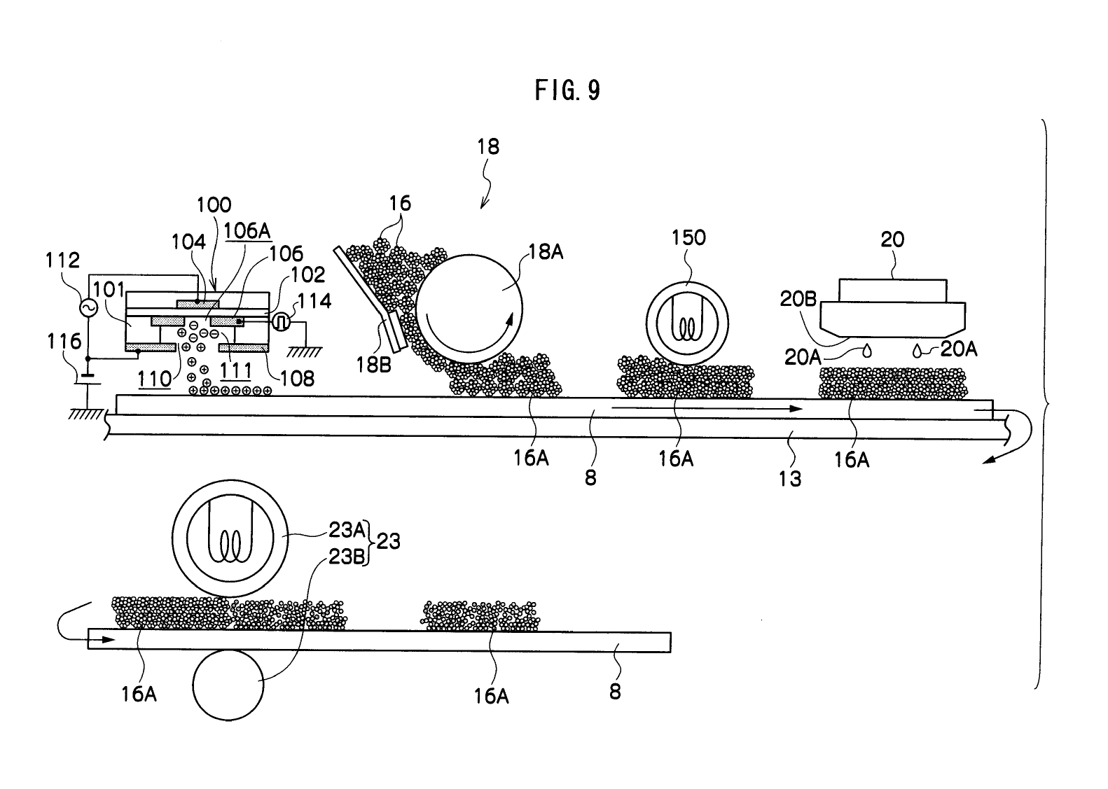

FIG. 8 is a configurational drawing showing a recording device according to another exemplary embodiment. FIG. 9 is a configurational drawing showing the main components of a recording device according to the other exemplary embodiment. A case in which composite particles are applied as ink receiving particles is described in the following other exemplary embodiment.

As shown in FIG. 8 and FIG. 9, a recording device 11 of the other exemplary embodiments has an endless belt-shaped conveyer belt 13. The conveyer belt 13 moves rotationally and conveys the recording medium 8 supplied from a storage container (not shown).

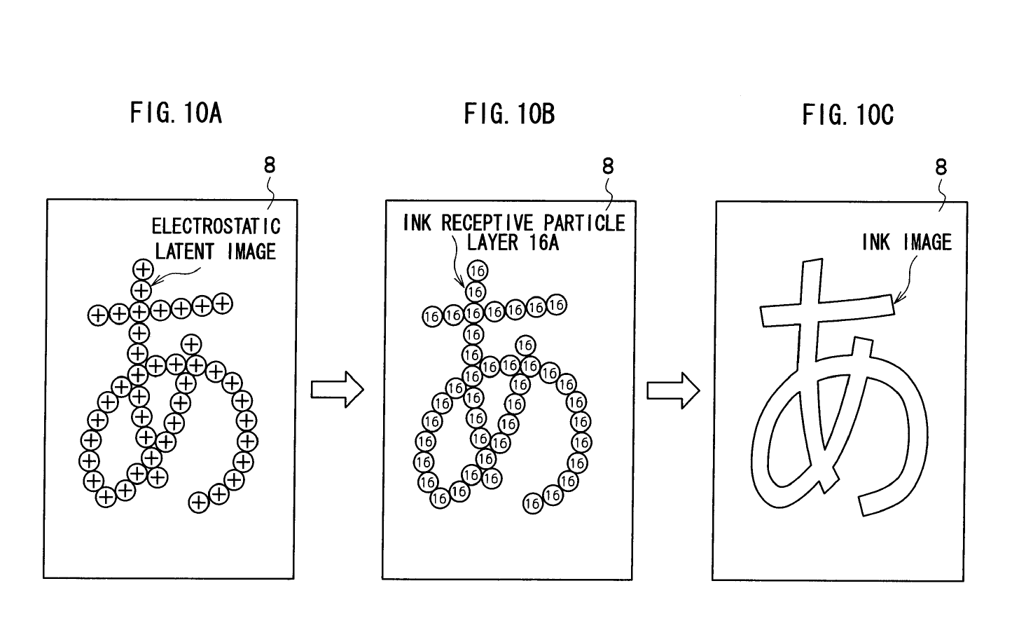

First, an electrostatic latent image is formed on the recording medium 8 being conveyed on the conveyer belt 13, when an ion flow control electrostatic recording head 100 (hereinafter, “electrostatic recording head 100”) controls an ion flow caused by discharge and the recording medium 8 is irradiated thereby (see FIG. 10A).

An ink receiving particle supply unit 18 effects visualization of the electrostatic latent image formed on the recording medium 8 to form the ink receiving particle layer 16A composed of the ink receiving particles 16 (see FIG. 10B).

A preliminary fixing device 150 preheats and fixes the ink receiving particle layer 16A formed on the recording medium 8.

Based on the image data, ink droplets 20A (see FIG. 9) of respective colors are ejected from inkjet recording heads 20K, 20 C, 20M and 20Y for the respective colors black (K), cyan (C), magenta (M), and yellow (Y), onto the ink receiving particle layer 16A that has been preheated and fixed and, as a result, an ink image is formed (see FIG. 10C). Further, in the following, when it is necessary to distinguish between the respective colors, the letters Y, M, C, and K will be attached after reference numerals; however, when there is no particular need for distinguishing between the respective colors, the letters Y, M, C, and K are omitted.

The ink receiving particle layer 16A on which the ink image was formed by the ejection of ink droplets 20A is fixed onto the recording medium 8 by the application of pressure and heat from the fixing device 23.

Additionally, the electrostatic recording head 100 and the inkjet recording head 20 are line-type recording heads having a width equal to or larger than the width of the recording medium 8, which are known as FWA (Full Width Array) system recording heads.

Respective constituent elements and an image forming process are explained below in detail.

An endless belt-shaped conveyer belt 13 conveys the recording medium 8. In the present exemplary embodiment, the recording medium 8 is conveyed in a state in which it is adsorbed on the conveyer belt 13.

One example of the method for adsorbing the recording medium 8 to the conveyer belt 13 is to provide holes (not shown) in the conveyer belt 13 and to have a suction mechanism effect adsorption by suctioning through the holes. Other examples of the method for adsorbing the recording medium 8 to the conveyer belt 13 include a method of adsorption by adhesive force and a method of electrostatically adsorbing the recording medium 8 to the conveyer belt 13.

At an upstream side in the conveyance direction, the electrostatic recording heads 100 for forming an electrostatic latent image on the recording medium 8 conveyed by the conveyer belt 13, are deployed at an interval above the recording medium 8.

The electrostatic recording head 100 is provided with plural driving electrodes 104 disposed in parallel with each other on the surface of a planar rectangular insulation substrate 102, and with plural controller electrodes 106 disposed so as to intersect with the driving electrodes 104 at a back surface thereof. Further, a matrix (grating) is formed by the driving electrodes 104 and the controller electrodes 106. Further, at the controller electrodes 106, circular opening parts 106A are formed at positions of intersection with the driving electrodes 104. In addition, a screen electrode 108 is disposed at the lower surface of the controller electrode 106 via an insulation substrate 101. At the insulation substrate 101 and screen electrode 108, a space 111 and an ion extraction opening part 110 are formed at positions corresponding to the opening parts 106A of the controller electrodes 106.

High frequency high voltage is applied between the driving electrode 104 and the screen electrode 108 by an alternating current power source 112. Further, a pulse voltage corresponding to the image information is applied to the controller electrode 106 by an ion controlled power source 114. Further, DC voltage is applied to the screen electrode 108 by a direct-current power source 116.

Application of an alternating electric field between the driving electrodes 104 and the controller electrodes 106 thus insulated from each other induces creeping corona discharge in the space 111. Accelerating or absorbing the ions generated by the creeping corona discharge by means of the electric field formed between the controller electrodes 106 and the screen electrode 108, and controlling discharge of ion flow from the ion extraction opening part 110, an electrostatic latent image (see FIG. 10A) is formed on the surface of the recording medium 8 by the ions (plus ions in the present embodiment) corresponding to the image signal (ink image).

In the next process, the electric potential of the electrostatic latent image may be any potential capable of feeding/adsorbing the ink receiving particles 16 onto the recording medium 8 by means of the electrostatic force induced by the electric field formed by the electrostatic latent image formed on the recording medium 8 and by the particle feed roll 18A of the ink receiving particle supply unit 18.

Further, the electrostatic recording head 100 can select a region for forming the electrostatic latent image. Accordingly, the electrostatic latent image formed on the surface of the recording medium 8 is the region at which the ink image is formed. For example, FIG. 10A conceptually illustrates the formation of an electrostatic latent image of a Japanese hiragana character (pronounced “a”).

The recording medium 8, on the surface of which the electrostatic latent image has been formed, is sent to the ink receiving particle supply unit 18, and the electrostatic latent image is visualized, to form an ink receiving particle layer 16A corresponding to the electrostatic latent image (see FIG. 10B). As a result, the ink receiving particle layer 16A is formed only in the region on the recording medium 8 of the ink image to be formed based on the image signal (the ink receiving particle layer 16A is hardly formed at all in a non-image region).

Next, the description returns to the explanation of the image forming process.

Next, as shown in FIG. 10A, a preliminary fixing device 150 preliminarily fixes the ink receiving particle layer 16A formed on the recording medium 8.

The ink receiving particle layer 16A formed on the recording medium 8 is fixed to the recording medium 8 with electrostatic force. Accordingly, when the ink droplets 20A are ejected onto the ink receiving particle layer 16A from the inkjet recording head 20 in this state in the next process, the ink receiving particle layer 16A may be disturbed depending on the amount of ink. As a result, preliminary fixing of the ink receiving particle layer 16A in advance will temporarily fix the ink receiving particles 16 onto the surface of the recording medium 8.

Further, the preliminary fixing prevents scattering of the ink receiving particles 16 due to ejection of the ink droplets 20A and prevents contamination of the nozzle surface 20B of the inkjet recording head 20.

Preheating in the preliminary fixing device 150 is executed at a lower heating temperature than the heating for fixing in the final fixing device 23. In other words, the preliminary fixing in the preliminary fixing device 150 does not need to completely melt and fix the resin particles in the ink receiving particles 16 by pressure; rather, it is sufficient to bind the particles together and bind the particles with the surface of the recording medium, leaving voids between the particles. As a result preliminary fixing is accomplished to the extent that the ink droplets 20A can be received.

Further, as the preliminary fixing device 150, the general heat fixing device (fuser) used in the electrophotographic image forming apparatus can be applied. In addition, other than the heat fixing device used in the electrophotographic image forming apparatus, a heating process using a heater, a heating process using an oven, an electromagnetic induction heating process or the like can also be used.

Next, the recording medium 8, onto which the ink receiving particle layer 16A has been preliminarily fixed, is conveyed to below the inkjet recording head 20.

Then, based on the image data, the ink droplets 20A are ejected from the inkjet recording head 20, and are applied to the ink receiving particle layer 16A formed at the surface of the recording medium 8, and an ink image is formed (FIG. 10C). Here, the ink is received by the ink receiving particles 16.

Further, in order to write the image at high speed, a line-type inkjet recording head having a width equal to or larger than the width of the recording medium as in the present exemplary embodiment may be used; however, sequential formation of the image using a scanning type inkjet recording head may also be employed. Further, the ink ejection unit of the inkjet recording head 20 is not limited as long as it is an ink ejectable means such as a piezoelectric element driving type or an exothermic heat element driving type.

Then, the recording medium 8 is released from the conveyer belt 13 and sent to the fixing device 23. By applying pressure and heat to the ink receiving particle layer 16A, the ink receiving particle layer 16A is fixed onto the recording medium 8.

The fixing device 23 is configured by a heating roll 23A with a heat source built in and an opposing pressure roll 23B. The heating roll 23A and the pressure roll 23B contact each other to form a nip part. As the heating roll 23A and the pressure roll 23B, for example, rolls fabricated by covering silicone rubber over the outer surface of an aluminum core, and further covering with a PFA tube, are used. Further, the device has the same configuration as the fixing device (fuser) used in an electrophotographic image forming apparatus. Further, other than the heat fixing device used in the electrophotographic image forming apparatus, a heating process using a heater, a heating process using an oven, an electromagnetic induction heating process or the like can also be used.

When the recording medium 8 passes through the contact part between the heating roll 23A and the pressure roll 23B, the ink receiving particle layer 16A is heated and pressed and, as a result, the ink receiving particle layer 16A is fixed onto the recording medium 8. Further, other than the method of using both heating and pressing, a method of using only heating or of using only pressing may be applied. However, a method of heating and pressing simultaneously may also be used.

Via the above-mentioned process, image formation is completed and the recording medium 8 is outputted from the recording device.

In the recording device 11 according to the other exemplary embodiment described above, while conveying the recording medium 8 by means of the conveyer belt 13, an electrostatic latent image is formed by the electrostatic recording head 100, and the ink receiving particles 16 are supplied onto the electrostatic latent image from a particle supply unit 18, whereby a particle layer is formed. Then, ink droplets are ejected from the inkjet recording head 20 onto the particle layer, and the image is formed. As a result, the ink receiving particles 16 are made to receive the ink. Then, after the recording medium 8 is released from the conveyer belt 13, the ink receiving particle layer is fixed onto the recording medium 8 by the application of pressure and heat by the fixing device 23. Further, because the device 11 is similar to the recording device of the exemplary embodiment as described above except in terms of the above description, further explanation is omitted.

In the exemplary embodiments, ink droplets 20A are selectively ejected from the inkjet recording heads 20 in the respective colors of black, yellow, magenta, and cyan on the basis of image data, and a full-color image is recorded on the recording medium 8. However the invention is not limited to the recording of characters or images on a recording medium. That is, the liquid droplet ejection device according to the exemplary embodiments of the invention can be applied generally in liquid droplet ejection (jetting) devices used industrially.

### EXAMPLES

The present invention is more specifically described below with reference to examples. However, the respective examples do not limit the scope of the invention.

[Preparation of Particles]

### (Hydrophilic Resin)

Styrene/n-butylmethacrylate/acrylic acid copolymer (polar monomer ratio: 40% by mol, Mw=40,000) is prepared as the hydrophilic resin.

(Polymer Emulsion Liquid A)

Adding 10 parts by weight of the above hydrophilic resin into a mixture of 72 parts by weight of water and 18 parts by weight of isopropyl alcohol (IPA), the resultant mixture is roughly dispersed by means of a homomixer and, then, 5 weight % of sodium hydroxide aqueous solution is added such that the pH of the resultant liquid becomes 6.5. The resultant mixture liquid is emulsified by means of an ultrasonic homogenizer to obtain Emulsion Liquid A (solid content: 10% by weight).

(Polymer Emulsion Liquid B)

Adding 10 parts by weight of the hydrophilic resin into a mixture of 81 parts by weight of water and 9 parts by weight of isopropyl alcohol (IPA), the resultant mixture is roughly dispersed by means of a homomixer and, then, 5 weight % of sodium hydroxide aqueous solution is added such that the pH of the resultant liquid becomes 6.5. The resultant mixture liquid is emulsified by means of an ultrasonic homogenizer to obtain an Emulsion Liquid B (solid content: 10% by weight).

(Polymer Solution C)

Adding 10 parts by weight of the hydrophilic resin into 90 parts by weight of water, the resultant mixture is roughly dispersed by means of a homomixer and, then, 5 weight % of sodium hydroxide aqueous solution is added such that the pH of the resultant liquid becomes 10. The resultant mixture liquid is emulsified by means of an ultrasonic homogenizer to obtain Polymer Solution C (solid content: 10% by weight).

(Polymer Emulsion Liquid D)

Adding 50 parts by weight of the Polymer Solution C into 50 parts by weight of isopropyl alcohol (IPA), the resultant mixture liquid is emulsified (particulation) to obtain Emulsion Liquid D (solid content: 5% by weight).

(Polymer Emulsion Liquid E)

As the hydrophilic resin, styrene/acrylic acid copolymer (polar monomer ratio: 30% by mol, Mw=9,000) is used. 10 parts by weight of the hydrophilic resin are added to 90 parts by weight of water, the resultant mixture is roughly dispersed by means of a homomixer and, then, 5 weight % of sodium hydroxide aqueous solution is added such that the pH of the resultant liquid becomes 6.5. The resultant mixture liquid is emulsified by means of an ultrasonic homogenizer to obtain Emulsion Liquid E (solid content: 10% by weight).

(Polymer Emulsion Liquid F)

As the hydrophilic resin, styrene/n-butylmethacrylate/acrylic acid copolymer (polar monomer ratio: 30% by mol, Mw=100,000) is used. 10 parts by weight of the hydrophilic resin are added into a mixture of 63 parts by weight of water and 27 parts by weight of isopropyl alcohol (IPA), the resultant mixture is roughly dispersed by means of a homomixer and, then, 5 weight % of sodium hydroxide aqueous solution is added such that the pH of the resultant solution becomes 7. The resultant mixture liquid is emulsified by means of an ultrasonic homogenizer to obtain an Emulsion Liquid F (solid content: 10% by weight).

(Particles A to H)

Liquids or Solutions A, B, C, D, E, and F are respectively spray-dried by means of a spray drier device (product name: MINISPRAYDRIER B290 TYPE, manufactured by BUCHI Co., Ltd.; spray-drying conditions: operating spray gun aperture is 1.5 mm, inlet temperature is 160° C., aspirator setting is 100%, pump setting is 25%, outlet temperature is 60° C., sample feed rate is 7 mL/min) to obtain Particles A, B, C, D, E, and F.

Further, after freeze drying the Polymer Solution C, crushing and classification treatment are performed to obtain Particles G.

Still further, crushing treatment and classification treatment are performed on the hydrophilic resin, which is styrene/n-butylmethacrylate/acrylic acid copolymer (polar monomer ratio: 40% by mol, Mw=40,000), and particulation is achieved. 10 parts by weight of the resin particles are added into a mixture of 45 parts by weight of water and 45 parts by weight of isopropyl alcohol, and 5 weight % of sodium hydroxide aqueous solution is added thereto such that the pH of the resultant solution becomes 6.5. The resultant mixture liquid is subjected to a treatment by means of an ultrasonic homogenizer and then, after freeze drying the resultant mixture solution, crushing and classification treatment are performed to obtain Particles H.

### Examples 1 to 5, Comparative Examples 1 and 2

The following evaluations are conducted using the above respective particles (ink receiving particles) and the following ink as described in Table 1. The results are shown in Table 1.

(Preparation of Ink)

The following ink components are mixed and stirred and then an ink is prepared by filtration using a membrane filter having a pore size of 5 μm.
C. I. Pigment Blue 15:3: 7% by weight
Styrene—acrylic acid copolymer: 2.5% by weight
Glycerin: 10% by weight
Propylene glycol: 10% by weight
1,2-hexanediol: 5% by weight
OLFYN E1010 (available from NISSIN CHEMICAL INDUSTRY CO., LTD): 1.5% by weight
NaOH: Appropriate amount
Water: Remaining portion

The pH of the resultant ink is adjusted to 8.5 using sodium hydroxide aqueous solution. The ink exhibits surface tension of 31 mN/m.

(Evaluation)

Concerning the resultant particles, the following evaluations are conducted.

Particle Performance

Average spherical equivalent diameters of respective particles are measured using a laser diffraction particle size distribution analyzer (manufactured by HORIBA, LTD., LA-700), and the configuration thereof is observed using an SEM (Scanning Electron Microscope; magnification: 5,000 times). In addition, when the particles are configured as composite particles, the average spherical equivalent diameter of the constituent primary particles is decided as the average value of 100 primary particles selected at random from SEM observation images.

Neutralization Degree of Particles

The neutralization degrees of both the surface layer portion and the central portion (core part) of the respective particles are measured in accordance with the following method.

The average spherical equivalent diameters of the respective particles are measured in advance by a laser diffraction particle size distribution analyzer (manufactured by HORIBA, LTD., LA-700) as described above.

Five kinds of water/IPA mixed solution are used in order to measure the neutralization degrees. Five kinds of water/IPA solution are specifically water/IPA=100/0 (weight ratio) (first solution), water/IPA=75/25 (second solution), water/IPA=50/50 (third solution), water/IPA=25/75 (fourth solution), and water/IPA=0/100 (fifth solution).

The particles are added to the first solution, then stirred and dispersed, and the average spherical equivalent diameter of the particles in the solution is measured. Thereafter, a liquid component (supernatant) and a solid component are separated by a centrifugal separation treatment and, further, by a cleaning treatment using an IPA aqueous solution of the same concentration. Subsequently, the solid component (the particles) is added to the second solution and the same treatment and measurement performed and, further, the same treatments and measurements are performed with the particles in the third and the fourth solutions. Such operations are carried out using the five kinds of water/IPA mixed solution described above.

As a result of the measurement of the average particle diameter in the five kinds of water/IPA mixed solution by aforementioned operations, the average particle diameter first becomes equal or less than 30% of the original average diameter in the treatment by the third solution (water/IPA=50/50). The liquid component obtained by the third solution (water/IPA=50/50) is collected as “liquid b”. The liquid component obtained by the first solution (Water/IPA=100/0) and the liquid component obtained by the second solution (water/IPA=75/25) are collected as “liquid a”, and the liquid component obtained by the fourth solution (water/IPA=25/75) and the liquid component obtained by the fifth solution (water/IPA=0/100) are collected as “liquid c”.

With regard to liquid a, the consumption of KOH is measured in accordance with the JIS K2501 acid value potentiometry measurement method (a potentiometer and a pH meter are used in the measurement), and (A) the amount (mol quantity) of (COOH) is calculated. Subsequently, employing HCl aqueous solution as titration solution, the consumption of HCl is measured with regard to the supernatant liquid in accordance with the JIS K2501 acid value potentiometry measurement method (a potentiometer and a pH meter are used in the measurement), and (B) the amount (mol quantity) of (COO⁻) is calculated.

Further, with regard to liquid c, the measurement and calculation of (A) the amount (mol quantity) of (COOH) and (B) the amount (mol quantity) of (COO⁻) are also conducted.

From these results, using the equation “neutralization degree=[(B)−(A)]/(B)”, the neutralization degrees of both the surface layer portion and the central portion are determined. The neutralization degree of the surface layer of the hydrophilic particles is calculated from the result obtained using “liquid a”, and the neutralization degree of the in the central portion of the hydrophilic particles is calculated from the result obtained using “liquid c”.

Further, when the particles are configured as composite particles, the neutralization degrees of the constituent primary particles are measured.

Liquid Absorption Amount

The particles are spread on an intermediate medium (PET film) using a device which sprinkles a particle by static electricity (particle application amount: 5 to 12 g/m²) and ink is applied (4.5 g/m²) to the intermediate medium, on which the particles are spread, using a piezo-type inkjet device to form a solid image with an image area ratio of 1200×1200 dpi (dpi: number of dots per inch) (100% coverage pattern). Aroller (having an elastic layer of silicone rubber covered over the surface of a metal cylindrical core) is pressed against the formed image portion 0.3 seconds later with a load of 2×10⁴ Pa to measure the transfer amount of ink onto the side of the roller. The evaluation criteria are as follows.
A: There is no occurrence at all of print transfer in an enlarged image.
B: While there is occurrence of print transfer in an enlarged image, this cannot be discerned by the naked eye and is within a tolerable range.
C: Print transfer can be generally discerned by the naked eye; however, it is within the tolerable range.
D: Print transfer can be generally discerned by the naked eye and is outside the tolerable range.

Image Storability

In the same manner as above, the particles are spread on an intermediate medium (PET film) (particle application amount: 5 to 12 g/m²) and ink is applied (4.5 g/m²) to the intermediate medium, on which the particles are spread, using a piezo-type inkjet device to form a solid image with an image area ratio of 1200×1200 dpi (dpi: number of dots per inch) (100% coverage pattern). After press-contacting art paper, heating and transfer treatment are performed to obtain an image. The image is stored under ambient conditions of temperature of 30° C., and humidity of 80% RH, and image smudging after 1000 hrs is evaluated by visual observation. The evaluation criteria are as follows.
A: There is no occurrence at all of image smudging in an enlarged image.
B: While there is occurrence of image smudging in an enlarged image, this cannot be discerned by the naked eye and is within a tolerable range.
C: Image smudging can be generally discerned by the naked eye; however, it is within the tolerable range.
D: Image smudging can be generally and is outside the tolerable range.

TABLE 1

| | Particles | | | | | | | | |
|---|---|---|---|---|---|---|---|---|---|
| | | | | | | | Weight | | |
| | | Particle Configuration | | | Neutralization | | Average | | |
| | | | Average | | Degree | | Molecular | Evaluation | |
| | | | Spherical | | Surface | | Weight of | Liquid | |
| | | Particle | Equivalent | Primary | Layer | Center | Hydrophilic | Absorption | Image |
| | Kind | Configuration | Diameter | Diameter | Portion | Portion | Resin | Amount | Storability |
| Example 1 | A | Composite | 6 μm | 580 nm | 0.5 | 0.05 | 40,000 | B | A |
| Example 2 | B | Composite | 7 μm | 275 nm | 0.45 | 0.1 | 40,000 | A | B |
| Example 3 | E | Composite | 7 μm | 300 nm | 0.6 | 0.1 | 9,000 | B | C |
| Example 4 | F | Composite | 7 μm | 560 nm | 0.5 | 0 | 100,000 | C | A |
| Example 5 | H | Primary | 8.5 μm | — | 0.55 | 0 | 40,000 | B | A |
| Comparative | C | Primary | 7 μm | — | 0.7 | 0.7 | 40,000 | B | D |
| Example 1 | | | | | | | | | |
| Comparative | D | Composite | 7 μm | 540 nm | 0.7 | 0.7 | 40,000 | A | D |
| Example 2 | | | | | | | | | |
| Comparative | G | Primary | 7 μm | — | 0.7 | 0.7 | 40,000 | C | D |
| Example 3 | | | | | | | | | |

From the results, it is evident that both the liquid absorption amount and the image storability in the Examples are superior to the Comparative Examples, and that compatibility has been realized between these two properties. In particular, those of the Examples with composite particles or employing a predetermined weight average molecular weight are clearly superior in terms of these properties.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. Ink receiving particles for receiving an ink comprising: hydrophilic particles that contain a hydrophilic resin, the neutralization degree of the hydrophilic resin at a surface layer portion of the hydrophilic particles being higher than the neutralization degree of the hydrophilic resin at a central portion of the hydrophilic particles.

2. The ink receiving particles of claim 1, wherein the weight average molecular weight of the hydrophilic resin is from about 10,000 to about 50,000.

3. The ink receiving particles of claim 1, in which at least the hydrophilic particles are aggregated.

4. The ink receiving particles of claim 1, wherein the neutralization degree of the hydrophilic resin at the surface layer portion of the hydrophilic particles is from about 0.1 to about 1.

5. A recording device comprising:
a supply unit that supplies ink receiving particles for receiving an ink onto a recording medium or an intermediate transfer member, the ink receiving particles having hydrophilic particles that contain a hydrophilic resin and the neutralization degree of the hydrophilic resin at a surface layer portion of the hydrophilic particles being higher than the neutralization degree of the hydrophilic resin at a central portion of the hydrophilic particles;
an ejection unit that ejects an ink toward the ink receiving particles that have been supplied onto the recording medium or the intermediate transfer member; and
a fixing unit that fixes the ink receiving particles onto the recording medium.

6. The recording device of claim 5, wherein
the supply unit supplies the ink receiving particles onto the intermediate transfer member;
the ejection unit ejects the ink onto the ink receiving particles that have been supplied onto the intermediate transfer member; and
the recording device further has a transfer unit that transfers the ink receiving particles onto the recording medium.

7. The recording device of claim 5, wherein the weight average molecular weight of the hydrophilic resin is from about 10,000 to about 50,000.

8. The recording device of claim 5, wherein the ink receiving particles are composite particles in which at least the hydrophilic particles are aggregated.

9. The recording device of claim 5, wherein the neutralization degree of the hydrophilic resin at the surface layer portion of the hydrophilic particles is from about 0.1 to about 1.

10. A material for recording comprising an ink and the ink receiving particles of claim 1.

11. The material for recording of claim 10, wherein the weight average molecular weight of the hydrophilic resin is from about 10,000 to about 50,000.

12. The material for recording of claim 10, wherein the ink receiving particles are composite particles in which at least the hydrophilic particles are aggregated.

13. The material for recording of claim 10, wherein the neutralization degree of the hydrophilic resin at the surface layer portion of the hydrophilic particles is from about 0.1 to about 1.

14. An ink receiving particle storage cartridge that is detachably disposed in a recording device and that stores the ink receiving particles of claim 1.

15. The ink receiving particle storage cartridge of claim 14, wherein the weight average molecular weight of the hydrophilic resin is from about 10,000 to about 50,000.

16. The ink receiving particle storage cartridge of claim 14, wherein the ink receiving particles are composite particles in which at least the hydrophilic particles are aggregated.

17. The ink receiving particle storage cartridge of claim 14, wherein the neutralization degree of the hydrophilic resin at the surface layer portion of the hydrophilic particles is from about 0.1 to about 1.
